(19) United States
(12) Patent Application Publication
(10) Pub. No.: US 2023/0194012 A1
(43) Pub. Date: Jun. 22, 2023

(54) MODULAR BLAST GATE FOR A DUST COLLECTION SYSTEM AND SYSTEM INCORPORATING SAME

(71) Applicant: WOODPECKERS, LLC, Strongsville, OH (US)

(72) Inventor: Mark Robert HEATH, JR., Strongsville, OH (US)

(73) Assignee: WOODPECKERS, LLC, Strongsville, OH (US)

(21) Appl. No.: 17/558,812

(22) Filed: Dec. 22, 2021

(51) Int. Cl. F16K 27/02; A47L 9/24; F16K 1/22; A47L 7/00

(52) U.S. Cl. CPC F16K 27/0218; A47L 9/248; F16K 1/22; A47L 7/0095; A47L 9/242

(57) ABSTRACT

A modular blast gate for a dust collection system. The blast gate includes first and second regions. The first region has a first configuration and enables securement of a duct of the dust collection system to the first region via a first connector mechanism. The second region has a second configuration different from the first configuration and enables securement of the duct to the second region via a second connector mechanism different from the first connector mechanism. The blast gate is usable to connect differently configured ducts, hoses, or pipes to equipment that generates particulate material. The blast gate is mountable to the equipment or a support surface. Two of the modular blast gates may be joined to one another to enable two ducts to be connected together.

### TECHNICAL FIELD

This disclosure is generally directed to equipment that generates dust, chips, filings or other debris material during operation. More particularly, the present disclosure relates to systems for collecting or extracting the dust, chips, filings, or other debris material generated during operation of such equipment. Specifically, the present disclosure is directed to a modular blast gate for use in a dust collection or extraction system, wherein the blast gate includes a first region which enables securement of a duct via a first connector mechanism, and a second region which enables securement of the duct via a different connector mechanism. A valve, particularly a butterfly valve, is utilized to selectively control flow of generated dust, chips, filings or other debris materials thorough a passageway defined in the blast gate and into a duct of the dust collection or extraction system.

### BACKGROUND

### Background Information

Woodworkers frequently connect woodworking tools in their workshops to dust collection systems in order to collect and dispose of sawdust, small woodchips, and other debris materials generated during operation of the woodworking tools. Typically, a dust collection system (also known as a dust extraction system) comprises a collection apparatus and ductwork or pipes that connect the collection apparatus to various woodworking tools in the workshop. The collection apparatus generates a vacuum that sucks air proximate the woodworking tool through the ducts and then the sawdust, woodchips, and other debris materials are filtered from that air by the collection apparatus.

Typical dust collection systems may include one or more blast gates provided at various locations in the ductwork. The blast gates are provided to allow the woodworker to selectively operate the dust collection system to extract debris materials generated by a particular woodworking tool. When a particular piece of woodworking equipment is to be used in the workshop, the associated blast gate will be moved to an open position to ensure that the dust collection system will remove generated debris materials from operation of that particular piece of equipment. When the particular piece of woodworking equipment is no longer being used, the blast gate is moved to the closed position and dust collection at that particular location will cease. The woodworker may then open another blast gate in the dust collection system to collect debris materials generated by operating a different piece of woodworking equipment. In some dust collection systems, blast gates may be manually operated by the woodworker. In other dust collection systems, the blast gates may be automatically opened when a particular tool is operated and will automatically be closed when operation of that particular tool ceases.

Prior art blast gates in dust collection systems typically comprise a housing having an opening defined therethrough. An annular flange extends outwardly away from a front or rear surface of the housing, with the annular flange circumscribing the opening. Opposing grooves are defined in a region of the housing that bounds and defines the opening. A slot is defined in a side wall of the housing and the slot is in fluid communication with the opening. A slidable plate is introduced into the slot and is received in the opposed grooves. The plate is operable to move linearly along the grooves in a first direction to close off the opening and is operable to move linearly along the grooves in a second direction to allow access to the opening. In other words, the blast gate is provided with a gate valve.

One end of a duct, pipe, or hose is connected to the flange on the blast gate and an opposite end of the duct is operably engaged with a collection apparatus. The duct, pipe, or hose is typically secured to the blast gate by a hose clamp or a quick connect mechanism. When the duct is so connected, a bore of the duct is placed in fluid communication with the opening defined in the blast gate. The housing is positioned proximate the piece of woodworking equipment from which generated debris material is desired to be removed. When the piece of equipment is not in operation, the plate of the gate valve slides linearly in a first direction to cut off fluid communication between the bore of the duct and the opening in the housing (and thereby to the air surrounding the piece of woodworking equipment. When the piece of equipment is to be operated, the gate valve is opened, i.e., the plate slides linearly in a second direction along the grooves and allows fluid communication between the bore of the duct and the opening of the blast gate, and thereby access to the air surrounding the piece of equipment.

In other instances, the blast gate includes a first annular flange that extends outwardly from the blast gate housing in a first direction and a second annular flange that extends outwardly from the blast gate housing in a second direction. The first flange is connectable to a first duct, hose, or pipe by a first hose clamp. The second flange is connectable to a second duct, hose, or pipe by a second hose clamp. In other words, the blast gate may be an inline blast gate positioned somewhere a distance away from a woodworking tool and a distance away from the collection apparatus. The bore of the first duct is able to be placed in fluid communication with the bore of the second duct by moving the gate valve to the open position. When the gate valve is opened, the air surrounding the woodworking equipment is able to be placed in fluid communication with the collection apparatus via the first duct and second duct. Fluid communication between the bore of the first duct and the bore of the second duct is cut off by closing the gate valve.

The housing of a blast gate defines an opening therethrough that extends from an outer end of the first flange to an outer end of the second flange. The opening is able to be placed in fluid communication with a bore of a duct or pipe of the dust collection system connected thereto. When fluid communication is established and a collection apparatus of the dust collection system is activated to generate a vacuum, air will be drawn through the opening in the blast gate housing and into the bore of the duct or pipe engaged therewith. When air is drawn into the duct or pipe, that moving air entrains sawdust and small woodchips from the woodworking tool into the same and the sawdust and woodchips are ultimately deposited into a collection region of the collection apparatus. Blast gates include a gate which is selectively movable in a first direction to close off the opening in the housing to prevent air flow into the bore of the duct or pipe. The gate is also movable in a second direction to place the opening in fluid communication with the bore of the duct or pipe and allow air to be sucked into the duct or pipe. The gate valve may be manually operated by the woodworker when he or she is ready to use a particular piece of woodworking equipment. In other instances, the plate of the gate valve may be automatically moved by an automated dust collection system when woodworking equipment is turned on and off.

It is not uncommon in woodworking environments for sawdust and small woodchips to accumulate in the grooves defined in the blast gate housing and along which the plate of the gate valve travels. This accumulation can make it relatively difficult to slide the plate in either of the first and second directions. Additionally, when the gate is moved to the open position, the plate may not slide completely out of the opening defined in the housing and may therefore partially occlude the opening to the vacuum hose. This partial obstructing of the opening will tend to reduce the efficiency of the dust extraction operation. Furthermore, the accumulation of sawdust and the like in the grooves defined in the housing may also in the plate of the gate valve failing to completely close off access to the opening and thereby to the bore of the duct or pipe. This failure of the gate valve to fully close may cause the collection apparatus of an automated dust collection system to continue to operate instead of automatically shutting off.

### SUMMARY

A modular blast gate for a dust collection system, a dust collection system including the blast gate, and a method of removing debris material from a piece of equipment performing an operation is disclosed herein. The blast gate includes first and second regions. The first region has a first configuration and enables securement of a duct of the dust collection system to the first region via a first connector mechanism. The second region has a second configuration different from the first configuration and enables securement of the duct to the second region via a second connector mechanism different from the first connector mechanism. The blast gate is usable to connect differently configured ducts, hoses, or pipes to equipment that generates particulate material. The blast gate is mountable to the equipment or a support surface. Two of the modular blast gates may be joined to one another to enable two ducts to be connected together.

The dust collection system includes at least one duct which connects the piece of equipment to a remote dust collection apparatus. The disclosed blast gate is engageable with the at least one duct and includes a housing defining a passageway therethrough. A valve, particularly a butterfly valve, is provided in the passageway and is selectively movable via an actuator between a closed position and an open position. When the valve is in the open position, fluid communication is established between the piece of equipment and the dust collection apparatus via the passageway. When the valve in the closed position fluid communication between the piece of equipment and the dust collection apparatus is prevented.

The blast gate disclosed herein is a modular component which enables a woodworker or other person to connect any one of a wide variety of different ducts, hoses, or pipes into a dust collection system or dust extraction system. Additionally, the modular blast gate disclosed herein enables the woodworker or other person to use any one of a wide variety of different connector mechanisms to secure a duct, hose or pipe to the blast gate. Furthermore, two of the disclosed modular blast gates may be combined into a single device to connect two ducts, hoses, or pipes to one another. The disclosed combined blast gates may enable the woodworker or other person to use different connector mechanism to secure the two ducts, hoses, or pipes to one another. For example, a first of the two ducts may be secured to one of the combined blast gates via friction and a second of the two ducts may be secured to the other of the combined blast gates via a clamp-type connector mechanism. Additionally, the disclosed blast gate is configured to enable the blast gate to be connected to a mounting plate to secure the blast gate to a piece of equipment (or the blast gate may be connected to the equipment without the mounting plate). Furthermore, the disclosed blast gate may be secured to a support surface such as a wall or, as discussed above, the blast gate may be secured to another blast gate and the combined blast gates may then be secured to a support surface, such as a wall. In summary, the disclosed blast gate is a modular component that is adapted to be connected to any duct or tool, i.e., piece of equipment that generates dust, shavings, and the like.

In one aspect, an exemplary embodiment of the present disclosure may provide a blast gate for use in a dust collection system, said blast gate comprising a first region of a first configuration, said first region being adapted to selectively enable securement of a duct to the first region via a first connector mechanism; and a second region of a second configuration different from the first configuration, said second configuration being adapted to selectively enable securement of the duct to the second region via a second connector mechanism which is different from the first connector mechanism.

In one aspect, an exemplary embodiment of the present disclosure may provide a blast gate for use in a dust collection system, said blast gate comprising a base; a flange extending outwardly from the base in a first direction and terminating in an outer edge remote from the base; a passageway defined through the base and the flange, wherein the passageway is adapted to be connected to a bore defined in a duct of the dust collection system; a valve disposed within the passageway and being movable between an open position and a closed position; wherein a first region of the flange is of a first configuration adapted to selectively enable securement of the duct to the flange via a first connector mechanism; and wherein a second region of the flange is of a second configuration different from the first configuration, wherein the second configuration is adapted to selectively enable securement of the duct to the flange via a second connector mechanism which is different from the first connector mechanism.

In one aspect, an exemplary embodiment of the present disclosure may provide a dust collection system comprising a dust collection apparatus; ductwork adapted to connect at least one piece of equipment to the dust collection apparatus; at least one blast gate connectable to the ductwork; wherein the at least one blast gate includes a first region of a first configuration to selectively enable securement of a duct of the ductwork to the at least one blast gate via a first connector mechanism; and wherein the at least one blast gate further includes a second region of a second configuration different from the first configuration, wherein the second configuration selectively enables securement of the duct of the ductwork to the at least one blast gate via a second connector mechanism which is different from the first connector mechanism.

In one aspect, an exemplary embodiment of the present disclosure may provide a dust collection system comprising a dust collection apparatus; ductwork adapted to connect at least one piece of equipment to the dust collection apparatus; and at least one blast gate connectable to the ductwork; wherein the at least one blast gate comprises a base; a flange extending outwardly from the base in a first direction and terminating in an outer edge remote from the base; a passageway defined through the base and the flange, wherein the passageway is placed in fluid communication with the ductwork; a valve disposed within the passageway and being movable between an open position and a closed position; wherein a first region of the flange is of a first configuration to selectively enable securement of a duct of the ductwork to the flange via a first connector mechanism; and wherein a second region of the flange is of a second configuration different from the first configuration, wherein the second configuration selectively enables securement of the duct of the ductwork to the flange via a second connector mechanism which is different from the first connector mechanism.

In one aspect, an exemplary embodiment of the present disclosure may provide a method of collecting debris material generated by a piece of equipment during performance of operation therewith, said method comprising providing a blast gate having a first region configured to be engageable by a duct via a first connector mechanism, and a second region configured to be engageable by the duct via a second connector mechanism that is different from the first connector mechanism; positioning the blast gate between the piece of equipment and the duct; connecting the duct to one of the first region and the second region via the respective one of the first connector mechanism and the second connector mechanism; terminating the duct in a remote dust collection apparatus, moving valve within the blast gate to an open position; placing the piece of equipment in fluid communication with the remote dust collection apparatus via the opened valve and the duct; suctioning air with entrained debris material generated by the piece of equipment through the opened valve and into the duct; and collecting the entrained debris material in the remote dust collection apparatus. In one embodiment, providing the valve may comprise providing a butterfly valve in the blast gate, wherein moving the valve to the open position comprises pivoting the butterfly valve about a pivot axis and into the open position.

In one aspect, an exemplary embodiment of the present disclosure may provide a dust collection system comprising a duct adapted to be connected to a remote dust collection apparatus; a blast gate engageable with the duct; a passageway defined through the blast gate; and a butterfly valve provided in the passageway, said butterfly valve being selectively pivotable between an open position and a closed position; wherein when the butterfly valve is in the open position, air is able to flow through the passageway and into the duct; and when the butterfly valve is in the closed position, air is not able to flow through the passageway and into the duct.

In another aspect, an exemplary embodiment of the present disclosure may provide a dust collection system comprising a dust collection apparatus; at least one piece of equipment for performing an operation; ductwork connecting the at least one piece of equipment to the dust collection apparatus; at least one blast gate connectable to the ductwork; and a butterfly valve provided in the at least one blast gate, said butterfly valve being selectively pivotable between an open position and a closed position; wherein when the butterfly valve is in the open position the dust collection apparatus is placed in fluid communication with the at least one piece of equipment by the ductwork and when the dust collection apparatus is actuated, air flows through the open butterfly valve moving in a direction towards the dust collection apparatus. When the butterfly valve is in the closed position, fluid communication between the piece of equipment and the dust collection apparatus is prevented.

In another aspect, and exemplary embodiment of the present disclosure may provide a method of collecting debris material generated by a piece of equipment during performance of operation therewith, said method comprising positioning a blast gate between the piece of equipment and at least one duct; connecting the at least one duct to a remote dust collection apparatus, pivoting a butterfly valve within the blast gate to an open position; placing the piece of equipment in fluid communication with the remote dust collection apparatus via the opened butterfly valve and the at least one duct; actuating the dust collection apparatus; actuating the piece of equipment; suctioning air with entrained debris material generated by the piece of equipment through the opened butterfly valve and into the duct; collecting the debris material with the remote dust collection apparatus; switching the piece of equipment off; and pivoting the butterfly valve to a closed position to prevent further fluid communication between the piece of equipment and the remote dust collection apparatus.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is a top, front, right side isometric perspective view of a first embodiment of a blast gate in accordance with the present disclosure, where the blast gate is shown on a piece of equipment and in a closed position;

FIG. 2 is a top, front, right side isometric perspective view of the blast gate illustrated at a different angle relative to FIG. 1, and showing a butterfly valve of the blast gate in the closed position;

FIG. 3 is a right side elevation view of the blast gate;

FIG. 3A is an exploded, top, perspective view of the components of the butterfly valve shown in isolation;

FIG. 4 is a top, front, right side isometric perspective view of the blast gate similar to FIG. 1 and showing the butterfly valve thereof moving from the closed position to an open position;

FIG. 5 is a top, front, right side isometric perspective view of the blast gate similar to FIG. 2 and showing the butterfly valve thereof in the open position;

FIG. 6 is a right side elevation view of the blast gate of FIG. 4;

FIG. 7 is a front elevation view thereof;

FIG. 8 is a rear elevation view thereof;

FIG. 9 is a top plan view thereof;

FIG. 10 is a bottom plan view thereof;

FIG. 11 is a top, front, right side isometric perspective view of the blast gate shown in the open position and readied to be engaged with a duct;

FIG. 12 is a top, front, right side isometric perspective view of the blast gate with a connector collar engaged with the duct and being lowered into engagement with the blast gate; and

FIG. 13A is top, front, right side isometric perspective view showing the duct secured to the blast gate via a clamp mechanism;

FIG. 13B is a top, front, right side isometric perspective view showing a smaller diameter duct engaged via friction on the tapered portion of the blast gate;

FIG. 13C is a top, front, right side isometric perspective view showing the duct secured to the blast gate via a quick connect mechanism;

FIG. 14 is a top, front, right side isometric perspective view of a second embodiment of a blast gate in accordance with the present disclosure, where the blast gate is shown in a closed position;

FIG. 15 is a top, front, right side isometric perspective view of the blast gate illustrated at a different angle relative to FIG. 14, and showing a butterfly valve of the blast gate in the closed position;

FIG. 16 is a right side elevation view of the blast gate of FIG. 14;

FIG. 17 is a top, front, right side isometric perspective view of the blast gate similar to FIG. 14 and showing the butterfly valve thereof moving from the closed position to an open position;

FIG. 18 is a top, front, right side isometric perspective view of the blast gate similar to FIG. 15 and showing the butterfly valve thereof in the open position;

FIG. 19 is a right side elevation view of the blast gate of FIG. 18;

FIG. 20 is a front elevation view thereof;

FIG. 21 is a rear elevation view thereof;

FIG. 22 is a top plan view thereof;

FIG. 23 is a bottom plan view thereof;

FIG. 24 is a top, front, right side isometric perspective view of the blast gate shown in the open position and readied to be engaged with a pair of opposed ducts;

FIG. 25 is a top, front, right side isometric perspective view of the blast gate with a connector collar engaged with each of the opposed ducts and being moved into engagement with the blast gate;

FIG. 26 is a top, front, right side isometric perspective view showing blast gate interposed between the two opposed ducts; and

FIG. 27 is a diagrammatic illustration of a dust collection system that includes one or more blast gates in accordance with the present disclosure.

Similar numbers refer to similar parts throughout the drawings.

### DETAILED DESCRIPTION

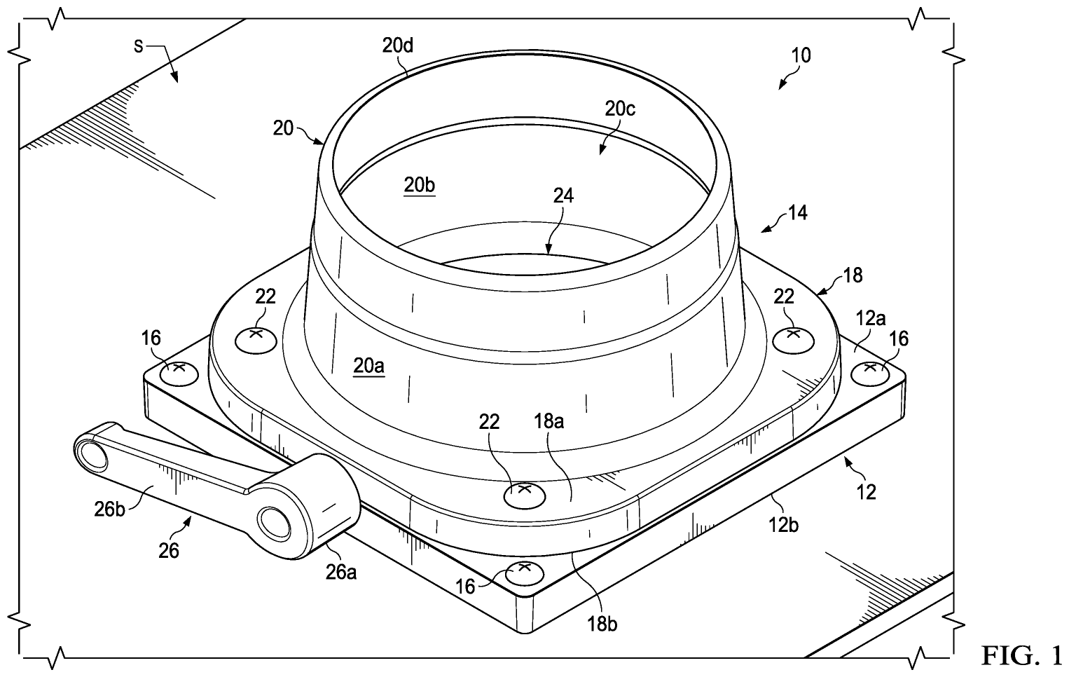

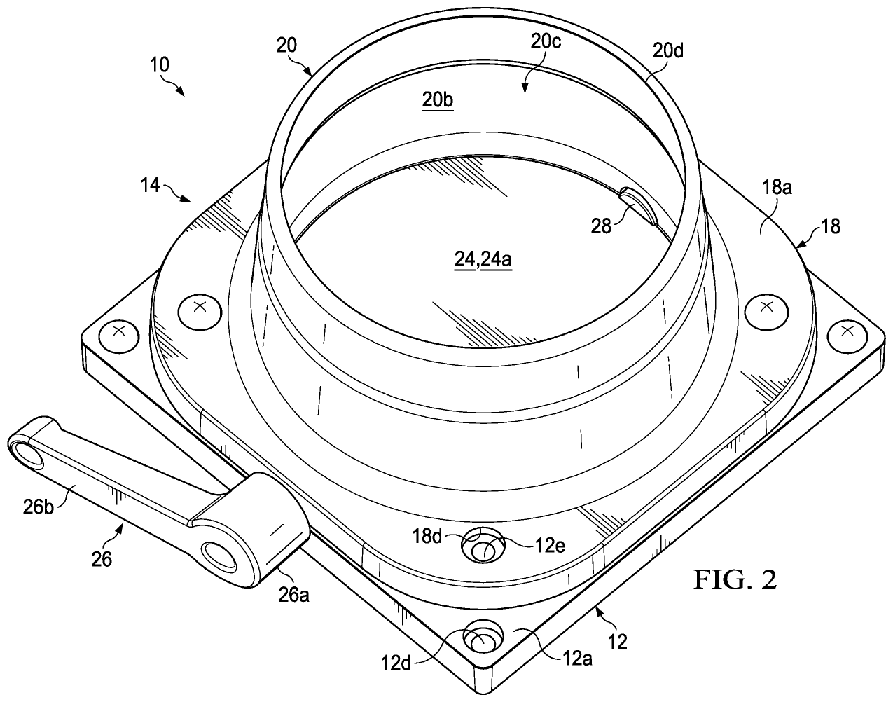

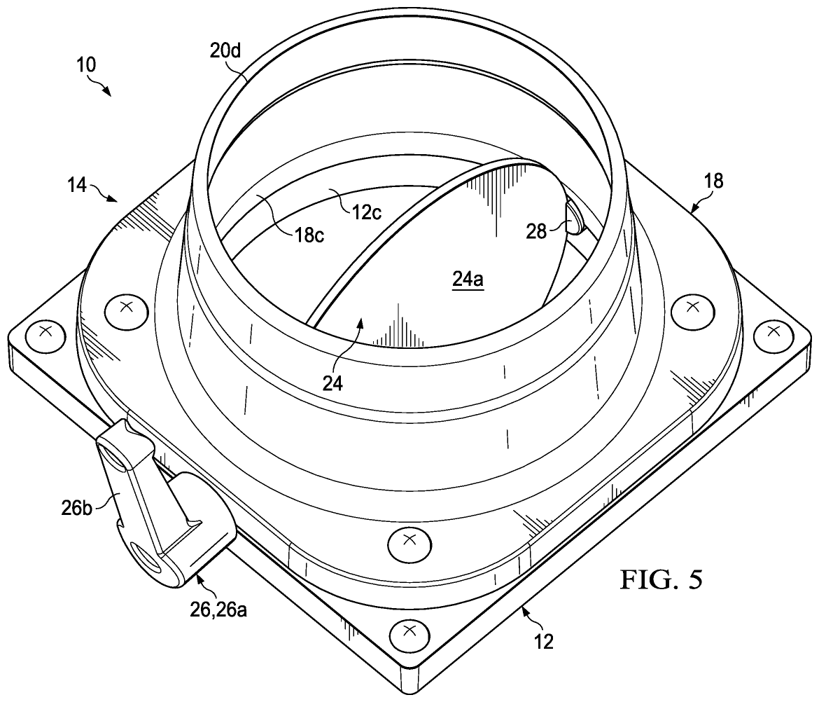

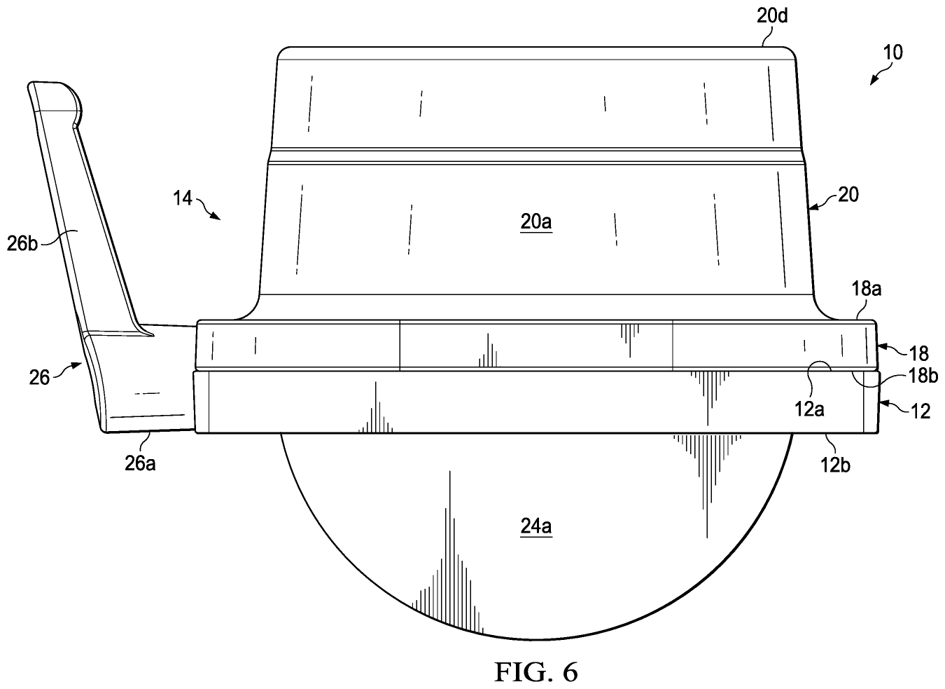

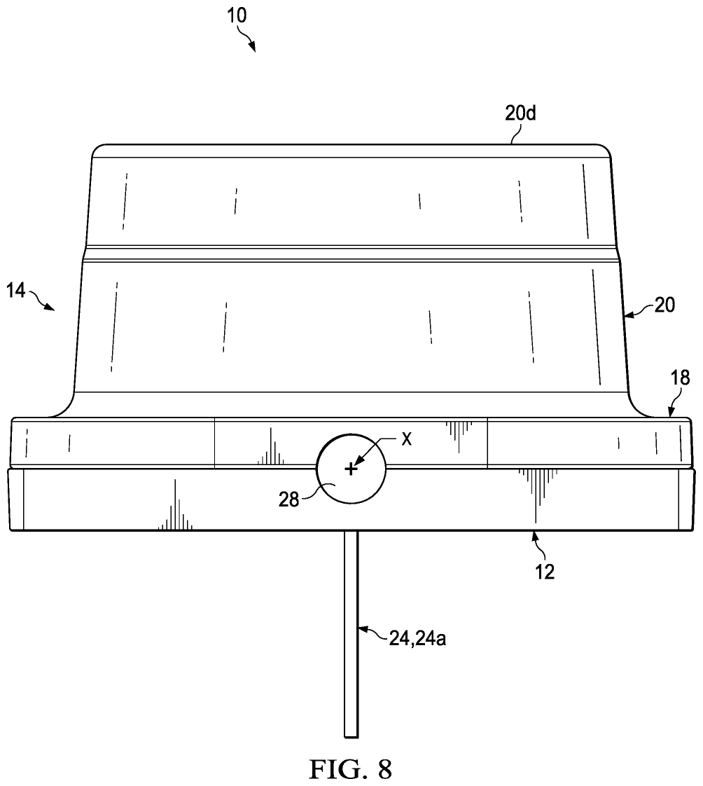

Referring to FIGS. 1-10 there is shown a first embodiment of a blast gate for a dust collection or extraction system in accordance with the present disclosure. The first embodiment of the blast gate is generally indicated at 10. Blast gate 10 is configured to be secured to a piece of equipment and to be connected to a duct of a dust collection or extraction system. Blast gate 10 is movable between a closed position (FIG. 2) and an open position (FIG. 5). When the piece of equipment is activated and dust or debris material is generated by the piece of equipment during the performance of an operation, the generated dust and debris material may be removed from the area by the dust collection system. In particular, the blast gate 10 is moved to the open position and the dust collection system sucks air through the blast gate 10 and into the duct, entraining dust, and debris material therein and thereby removing the same from the piece of equipment. In one embodiment, the piece of equipment is a piece of woodworking equipment such as a table saw and during a woodworking operation,

Blast gate 10 is comprised of a plate 12 and a housing 14. Plate 12, as illustrated, is substantially square in shape when viewed from above. It will be understood, however, that in other embodiments plate 12 may be of any other desired configuration when viewed from above including rectangular, circular, or triangular. The specific configuration of plate 12 may be selected based on the configuration of the piece of equipment to which blast gate 10 is to be secured.

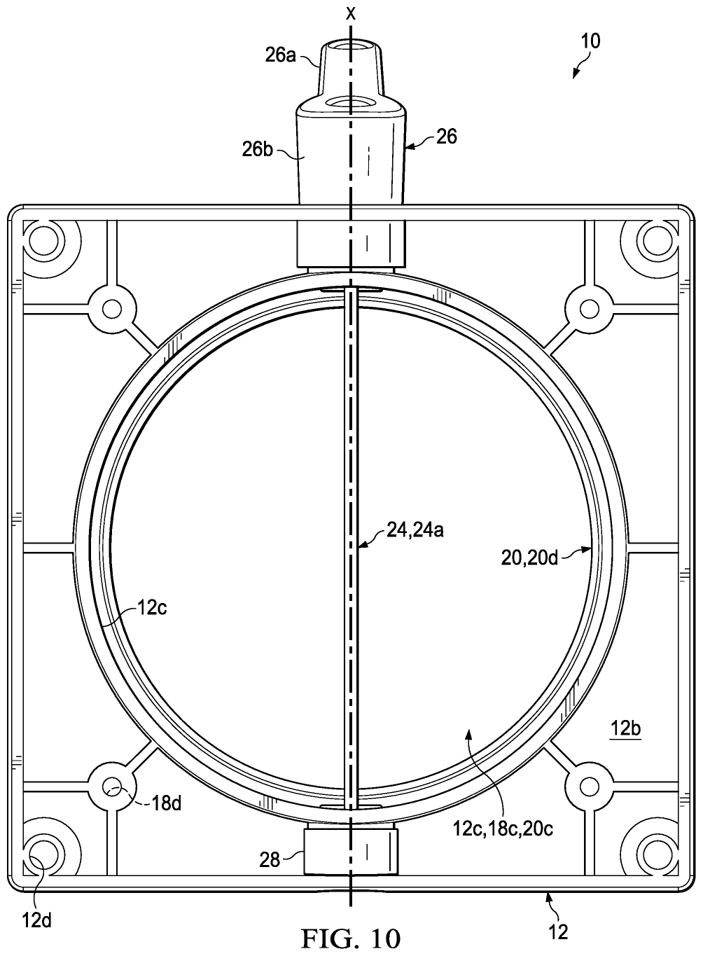

Plate 12 has an outer surface 12a and an inner surface 12b. A central aperture 12c is defined in plate 12 with central aperture 12c (FIG. 10) extending between outer surface 12a and inner surface 12b. Central aperture 12c, as illustrated, is circular in shape. It will be understood, however, that in other embodiments the shape of central aperture 12c may be of any other desired shape such as square or rectangular. A plurality of through-holes 12d is defined in plate 12. Each through-hole 12d extends from first surface 12a through to second surface 12b of plate 12. Through-holes 12d are illustrated as being located proximate the corners of the square plate 12. Fasteners 16 (FIG. 1) are inserted through the through-holes 12d in order to secure plate 12 to and are provided to receive fasteners 16 (FIG. 1) therethrough to secure plate 12 and thereby blast gate 10 to a surface of a piece of equipment. Plate12 also further defines a plurality of apertures 12e (FIG. 2) therein. Apertures 12e extend inwardly from first surface 12a of plate 12 through to second surface 12b. The purpose of apertures 12e will be described later herein.

Housing 14 is a single, integrally-formed, or unitary component that is comprised of a base 18 and an annular flange 20. Housing 14 may be molded as a single, unitary component. In other embodiments, base 18 and annular flange 20 may be fabricated as separate components that are later joined to one another by any suitable method.

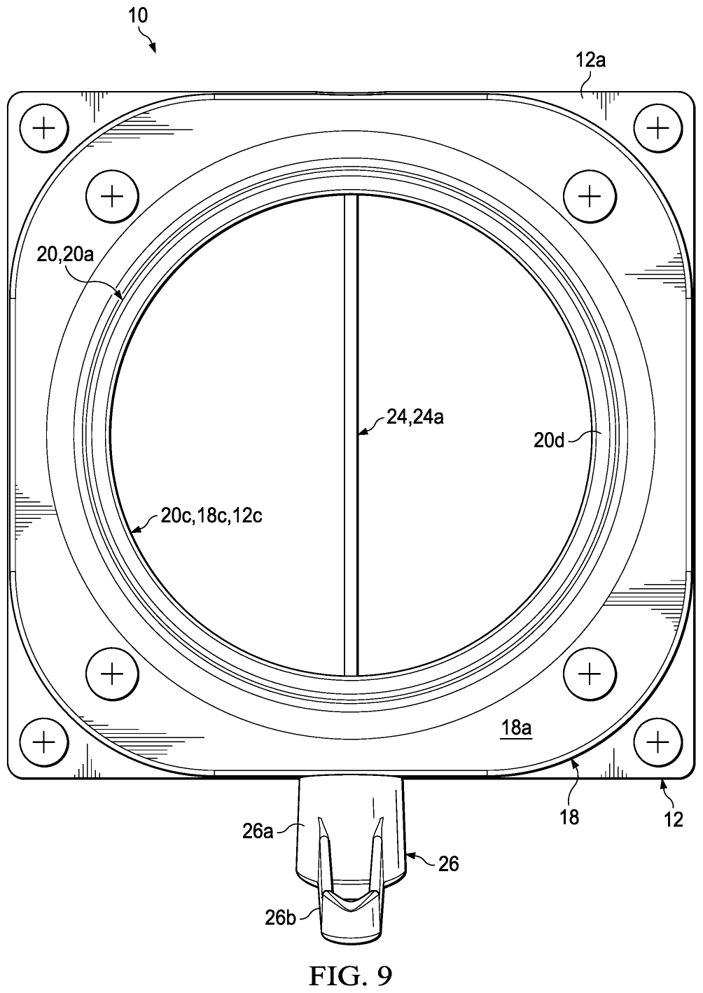

Base 18 has an outer surface 18a and an inner surface 18b. Base 18 is generally square in shape when viewed from above and is similarly sized to plate 12 except that base 18 has rounded corners and, consequently, corner regions of the plate 12 extend outwardly beyond the outer perimeter of base 18. If plate 12 is other than square in shape, base 18 may remain of the shape illustrated in FIG. 9 or may, alternatively, be similarly configured to the different shape of plate 12. A central aperture 18c is defined by base 18, with central aperture 18c (FIG. 5) extending between outer surface 18a and inner surface 18b of base 18. While opening 18c is described as a “central” opening, it will be understood that in other embodiments, the opening 18c may be located off-center.

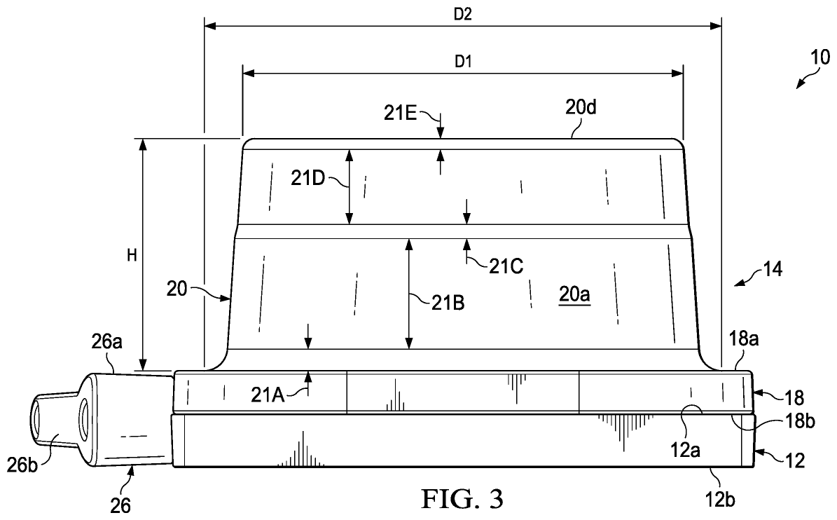

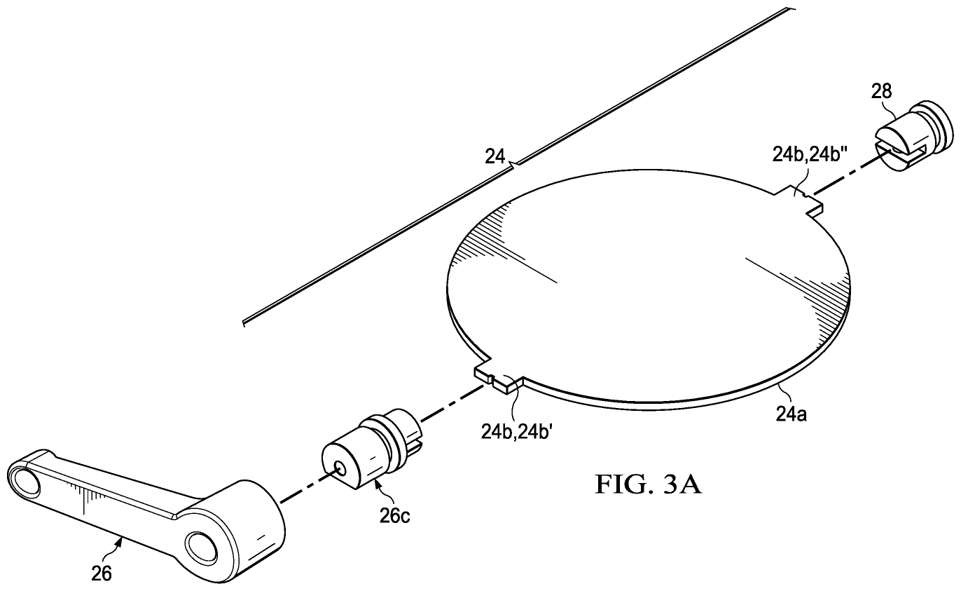

A plurality of through-holes 18d is defined in base 18, with each hole extending between outer surface 18a and inner surface 18b. Through-holes 18d are located proximate the rounded corners of plate 18 and are located to generally align with the plurality of apertures 12e (FIG. 2) defined in plate 12. Fasteners 22 are received through the through holes 18d and into the apertures 12e to secure base 18 to plate 12 and thereby to a support surface “S” of the piece of equipment. In some embodiments, through-holes 18d may be countersunk relative to outer surface 18a of base 18 such that the heads of the fasteners 22 are not visible when blast gate 10 is viewed from the side as in FIG. 3. It should be noted that when base 18 is secured to plate 12, the central aperture 18c of base 18 is aligned with the central aperture 12c of plate 12.

It will be understood that in some embodiments plate 12 may be omitted from blast gate 10 and fasteners 22 may be used to secure base 12 directly to the surface “S” of the piece of equipment. In yet other embodiments, plate 12 may be integrally formed with base 18 so that the blast gate 10 is a single, unitary component of monolithic nature.

Annular flange 20 extends upwardly and outwardly away from outer surface 18a of base 18. As best seen in FIG. 9, flange 20 is generally centrally located on base 18. Flange 20 has an outer surface 20a and an inner surface 20b. Outer surface 20a is substantially continuous with outer surface 18a of base 18. The inner surface 20b of flange 20 bounds and defines a central bore 20c. Central bore 20c is substantially continuous with the central aperture 18c defined by base 18. When base 18 is engaged with plate 12, central bore 20c, central aperture 18c, and central aperture 12c are in fluid communication with one another, are aligned with one another, and are substantially continuous.

Flange 20 terminates in an outer edge 20d that is located a distance outwardly away from outer surface 18a of base 18. Flange 20 is of a height “H” (FIG. 3) measured from edge 20d to outer surface 18a of base 18. FIG. 3 also shows that flange 20 tapers inwardly from outer surface 18a of base 18 through to outer edge 20d. Flange 20 is of a first diameter “D1” at outer edge 20d and is of a larger diameter “D2” at outer surface 18a of base 18.

FIG. 3 further shows that the angle of taper of outer surface 20a of flange 20 is not constant from outer surface 18a of base 18 to outer edge 20d. Effectively, flange 20 is formed into a first region 21A, a second region 21B; a third region 21C, a fourth region 21D, and a fifth region 21E. The angle of taper of first region 21A differs from the angle of taper of second region 21B, which may differ from the angle of taper of third region 21C, which may differ from the angle of taper of the fourth region 21D, which may differ from the angle of taper of the fifth region 21E. The differences in taper enables blast gate 10 to be effectively utilized with a variety of different diameter ducts, hoses, or pipes of a dust collection system or dust extraction system. Furthermore, the differences in taper enables a wide variety of different types of connector mechanism to be utilized to secure the ducts, hoses, or pipes to the blast gate 10. In other words the blast gate 10 is capable of being used in a wide variety of different types of dust collection system or dust extraction system with a wide variety of different connector mechanisms instead of a user having to provide and utilize a dedicated blast gate designed for a specific duct diameter or for a specific connector mechanism. Blast gate 10 is therefore capable of being used as a universal blast gate.

By way of example, second region 21B of blast gate 10 is oriented generally at 90° to outer surface 18a of base 18 or is only very slightly tapered relative to 90°, e.g. 88°. Additionally, second region 21B is of a greater length than first region 21A or third region 21C. This configuration of second region 21B presents a substantially constant diameter surface that is suitable for receiving a duct that requires a clamp-type connector mechanism to secure the duct to blast gate 10. By contrast, fourth region 21D is inclined at a greater angle relative to outer surface 18a of base 18 than is second region 21B. Fourth region 21D does not present a substantially constant diameter surface for engagement of a duct or hose. Instead, fourth region 21D presents a tapering diameter surface for engagement of the duct or hose. The tapering surface of fourth region 21D is such that if a clamp-type mechanism was needed to secure the duct in place, the clamp would slide off flange 20 and thereby be ineffective. The inclined/tapered surface presented by fourth region 21D is, however, particularly suitable for enabling a friction fit type of connection between blast gate 10 and a duct, pipe, or hose. (Second region 21B by contrast would not be suitable for a friction-fit type engagement of a duct or hose because of the substantially constant diameter of second region 21B.) The stepped arrangement of the outer surface 20a of flange 20 thereby aids in ensuring that the blast gate 10 is capable of being engaged with a variety of different diameter ducts, hoses, or pipes of a dust collection system or dust extraction system using a variety of different connector mechanisms. The configuration of flange 20 ensures that hose clamp type connectors, quick connect connectors, and friction-fit connection can be employed to secure a duct, hose, or pipe to blast gate 10.

The interior diameter of flange 20 is also tapered in a direction moving away from second surface 12b of plate 12 towards outer edge 20d of flange 20. A stepped arrangement similar to that provided on the outer surface 20a of flange 20 may be employed on the inner surface 20b thereof. In other embodiments, the inner surface 20b of flange 20 may be substantially smooth and continuous and will not include the stepped arrangement The tapering interior diameter of flange 20 will tend to accelerate the speed of air flowing through central bore 20c of flange 20 moving in a direction away from plate 12 and toward outer edge 20d of flange 20.

In view of the above, it will be understood that blast gate 10 defines a substantially continuous passageway therethrough with that passageway comprising central aperture 12c of plate 12, central aperture 18c of base 18, and central bore 20c of flange 20. The passageway extends from an opening to central aperture 12c defined by second surface 12b of plate 12 through to an opening to central bore 20c defined by outer edge 20d of flange 20.

In accordance with an aspect of the present disclosure, blast gate 10 further comprises a butterfly valve 24 and an actuator 26. Actuator 26 is operable to selectively move butterfly valve 24 from a closed position (FIG. 2) to an open position (FIG. 5).

Butterfly valve 24 comprises a valve disc 24a and a valve stem 24b. Valve disc 24a is a substantially flat plate which is circular in shape when viewed from above. Valve stem 24b is comprised of a first flange 24b′ and a second flange 24b″ that extend outwardly from a circumferential edge of valve disc 24a in opposite directions from one another as illustrated in FIG. 3A. In particular, first flange and second flange are arranged along a diagonal of the circular valve disc 24a and are, in one embodiment coplanar with the valve disc. In other words, valve disc 24a and valve stem 24b are integrally formed as a single component. A mounting assembly 28 is received in an aperture (not numbered) partially formed in plate 12 and partially formed in base 18. Mounting assembly 28 defines a slot therein for receiving one of the first flange and the second flange extending outwardly from the valve disc 24a. Actuator 26 includes a coupler 26c that defines a slot therein for receiving the other of the first flange and the second flange extending outwardly from the valve disc 24a therein. The mounting assembly 28 and the coupler 26c within actuator 26 effectively act as bushings that will allow valve disc to pivot easily relative to the rest of the housing 14

It will be understood that in other embodiments (not shown herein) the valve stem may be an elongate member that extends across passageway 12c, 18c, 20c and to which valve disc is secured in any suitable manner.

Valve stem 24b is selectively rotatable about a pivot axis “X” (FIG. 10) extending along valve stem 24b. Valve disc 24a is secured to valve stem 24b and as valve stem 24b is rotated (by manipulating actuator 26 as will be described later herein), valve disc 24a rotates. A region of the interior of the passageway 12c, 18c, 20c through blast gate 10 acts as a valve seat that will prevent valve disc 24b from rotating through 360°.

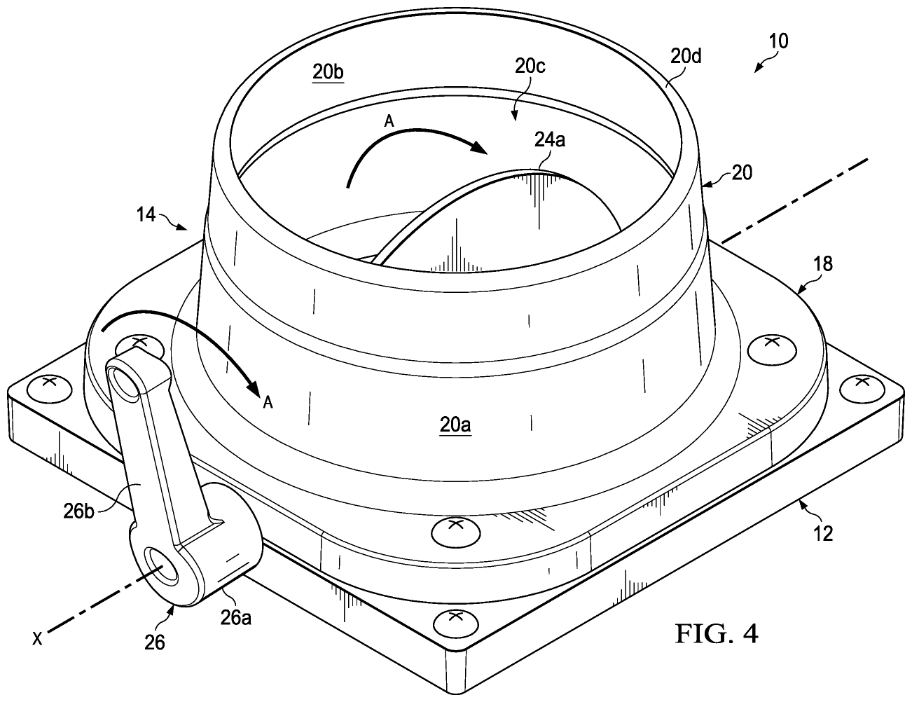

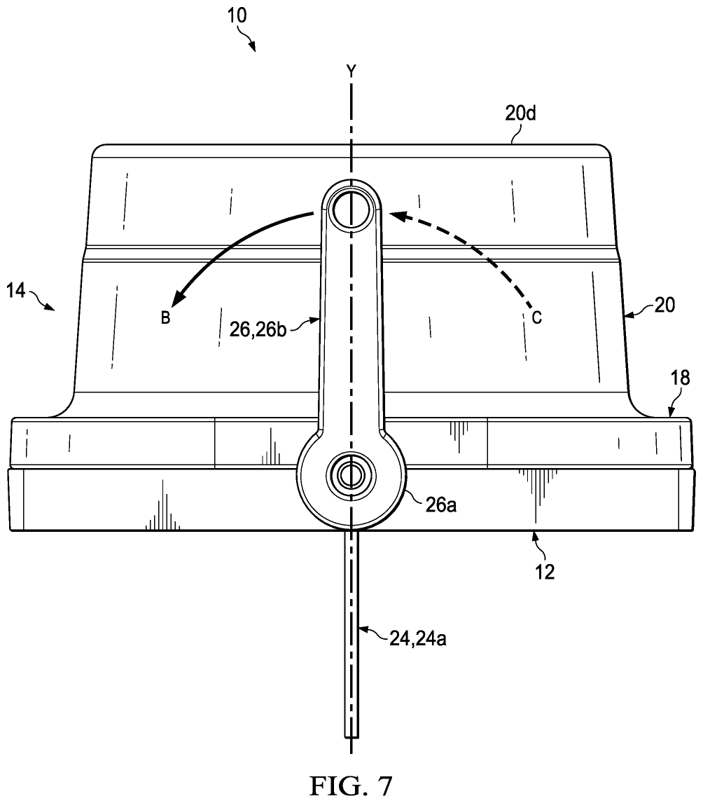

Actuator 26 may comprise a generally L-shaped handle having a barrel 26a and an arm 26b that extends outwardly from barrel 26a. Barrel 26a is secured into engagement with plate 12 and/or base 18 via valve stem 24b or via a fastener (not shown) which locks valve stem 24b in engagement with barrel 26a. Actuator 26 is engaged with valve stem 24 in such a way that actuator 26 and valve stem 24 are rotatable in unison about the X-axis. When the arm 26b of actuator 26 is aligned generally in a same plane as plate 12 and base 18, such as is illustrated in FIG. 3, butterfly valve 24 is in the closed position. In this closed position, valve disc 24a is oriented substantially parallel to outer surface 18a of base 18. When it is desired to open butterfly valve 24, actuator 26 is rotated in a first direction “A” (FIG. 4) about pivot axis “X”. As arm 26b of actuator moves in the first direction “A”, valve stem 24b (FIG. 3A) is also rotated in the first direction “A”, and therefore valve disc 24a is also rotated in the first direction “A” and into the open position. When butterfly valve 24 is fully open (as in FIG. 7), the arm 26a of actuator 26 is oriented at right angles to its original position. When it is desired to return the butterfly valve 24 to the fully closed position, arm 26b of actuator 26 is moved in a second direction “B” (FIG. 7). The second direction “B” is opposite to the first direction “A” (FIG. 4). As the arm 26b moves in the second direction “B”, valve stem 24b moves in the second direction “B” in unison with arm 26a. Furthermore, valve disc 24a moves in the second direction “B” in unison with valve stem 24b. Motion in the second direction “B” is halted by the valve disc 24b contacting a valve seat (not shown) provided within the passageway 12c, 18c, 20c through blast gate 10. The valve seat may comprise a narrower annular region extending into the passageway 12c, 18c, 20c or may comprise one or two small detents (not shown) that project into the passageway. Alternatively, a stop may be provided on one or more of valve stem 24b, actuator 26, and valve disc 24a that limits rotational travel of the butterfly valve about pivot axis “X” in first direction “A” and/or second direction “B”. It should be noted that, as illustrated, arm 26b is arranged substantially parallel to valve disc 24a and thus motion in arm 26b causes an identical motion in valve disc 24a.

In one embodiment, the rotational travel of actuator arm 26b about the pivot “X” axis may be limited to about 90° from an orientation substantially parallel to outer surface 18a of base 18 to an orientation substantially parallel to normal and therefore at right angles to outer surface 18a of base 18. Normal is indicated by the plane “Y” (FIG. 7) which passes through pivot axis “X”. In one embodiment, actuator arm 26b may selectively be moved in the direction of arrow “A” (FIG. 4) to move the butterfly valve 24 from the closed position to the open position or may be moved in the direction of arrow “C” (FIG. 7) to move the butterfly valve from the closed position to the open position. In this instance, the arm 26b may be moved in the opposite direction to arrow “A” or the opposite direction to arrow “C” to move the butterfly valve 24 back to the closed position. In this latter instance, the rotational travel of the butterfly valve is limited to about 90° on either side of normal, i.e., through 180° In yet other embodiments, the actuator 26 and therefore the butterfly valve may be anywhere from 0° through to 360°.

When butterfly valve 24 is in the closed position (FIG. 2), passageway 12c, 18c, 20c is closed off. In other words, air is unable to flow through passageway. When butterfly valve 24 is in the open position (FIG. 5), passageway 12c, 18c, 20c is no longer closed off and air is able to flow therethrough. Since the valve disc 24a is simply rotated about the pivot axis “X”, the rotational movement is able to be accomplished quickly and easily. Since the valve disc 24 does not ride along a pair of opposed grooves as occurs in PRIOR ART devices where a slide valve is used, the movement of the valve disc 24 is unimpeded by the build-up of sawdust and debris material in grooves. The valve disc 24 also fully closes off the passageway 12c, 18c, 20c when moved to the closed position. When moved to the fully open position, the valve disc 24 is oriented parallel to airflow through passageway 12c, 18c, 20c and therefore there is very little of the passageway blocked off by the valve disc.

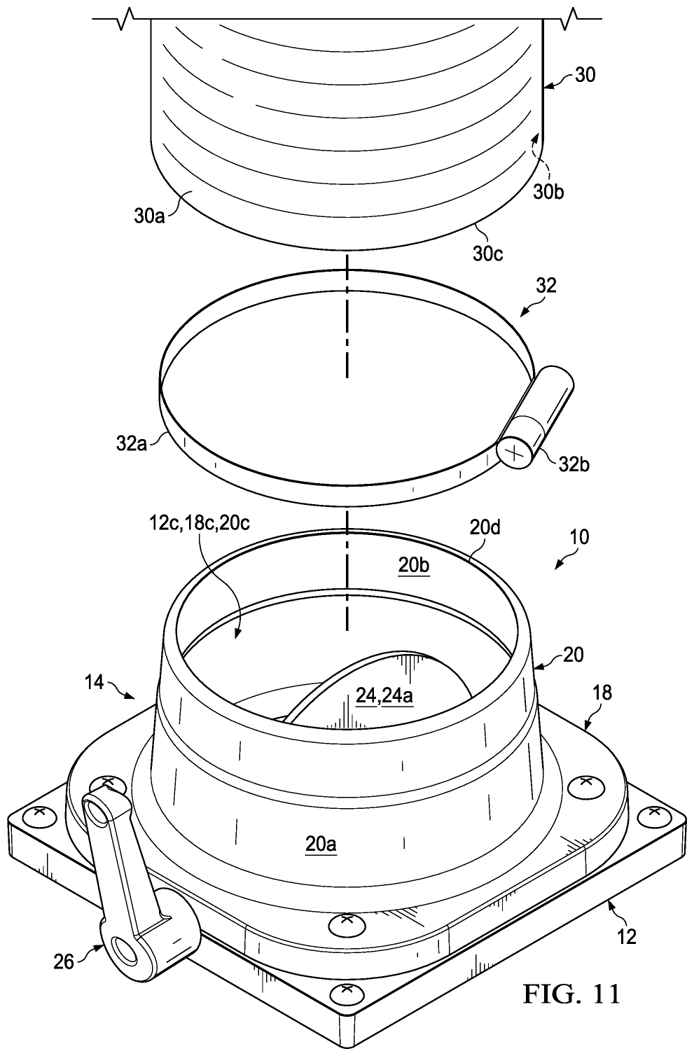

Referring now to FIGS. 11 through 13A, blast gate 10 is shown in use. As described earlier herein, plate 12 of blast gate 10 may be secured to piece of equipment by fasteners 16. In particular, blast gate 10 may be secured to a cabinet of the piece of equipment in such a location that the passageway 12c, 18c, 20c of blast gate 10 open us proximate a region of the piece of equipment where sawdust and/or other cuttings or debris material is generated. The opening to passageway 12c, 18c, 20c, defined by the second surface 12b of plate 12 forms a mouth of blast gate 10 through which the generated sawdust, cuttings or debris material may enter the passageway.

FIG. 11 shows a duct 30 and a clamp 32 positioned ready for engagement with flange 20 of blast gate 10. In particular, duct 30, clamp 32, and blast gate are aligned with one another. The duct 30 may be any suitable flexible or rigid ducting, hose, or pipe. Duct 30 has a circumferential wall 30a that bounds and defines an interior bore 30b. A first end 30c of duct 30 is engaged with blast gate 10, as will be described hereafter. A second end (not shown) of duct 30 is operatively engaged with a remote dust collection apparatus as will be later described herein.

The clamp 32 may be any suitable type of collar-type connector such as a tension clamp or a worm-gear clamp. Clamp 32, as illustrated, comprises a circular collar 32a which has a circumference that is selectively adjustable via an adjustment mechanism 32b. Initially collar 32a is of a first circumference that is greater than an exterior circumference of duct 30. Once adjustment mechanism 32b is activated, the circumference of collar 32a is reduced to substantially the same circumference as wall 30a of duct 30 or to even a slightly smaller circumference as wall 30a of duct 30. It should be understood that the illustrated clamp 32 is exemplary only and any suitable clamp-type connector mechanism may be utilized to secure duct 30 to blast gate 10.

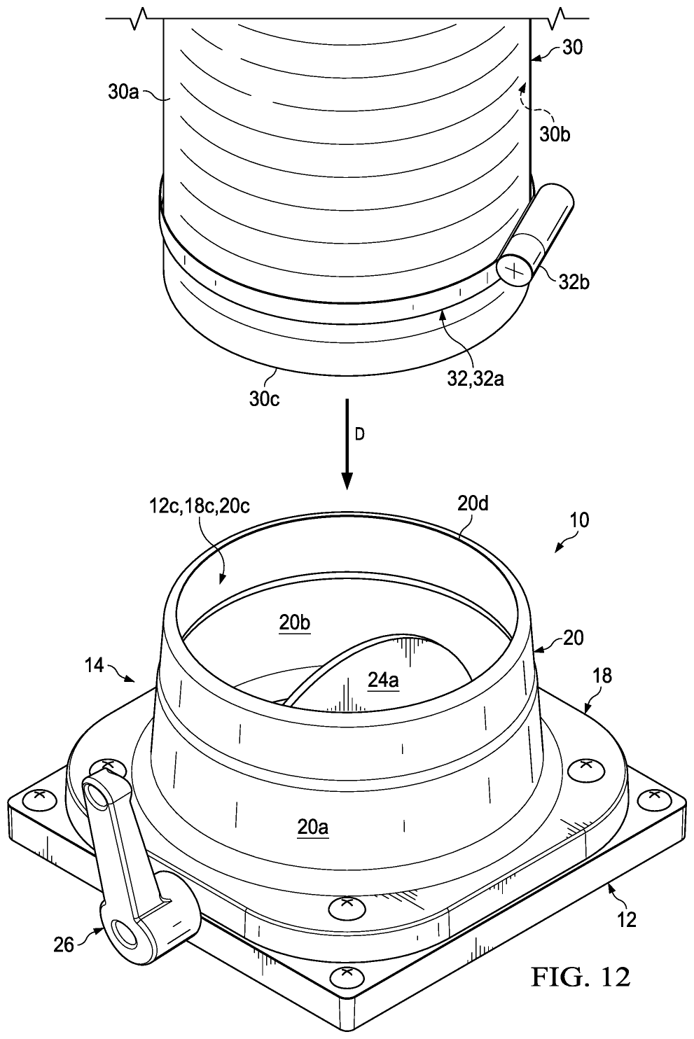

FIG. 12 shows clamp 32 engaged around wall 30a of duct 30. Clamp 32 is located a distance inwardly along wall 30 of duct 30 and away from the end 30c thereof. Duct 30 is moved downwardly towards blast gate 10 in a direction indicated by arrow “D” and so that end 30c of duct 30 will slide over the outer surface 20a of flange 20 of blast gate 10 and thereby circumscribe the outer surface 20a of flange 20. It should be noted that the tapering on flange 20 enables flange 20 to be readily inserted into the bore 30b of duct 30 and for duct 30 to slide over flange 20 and towards outer surface 18a.

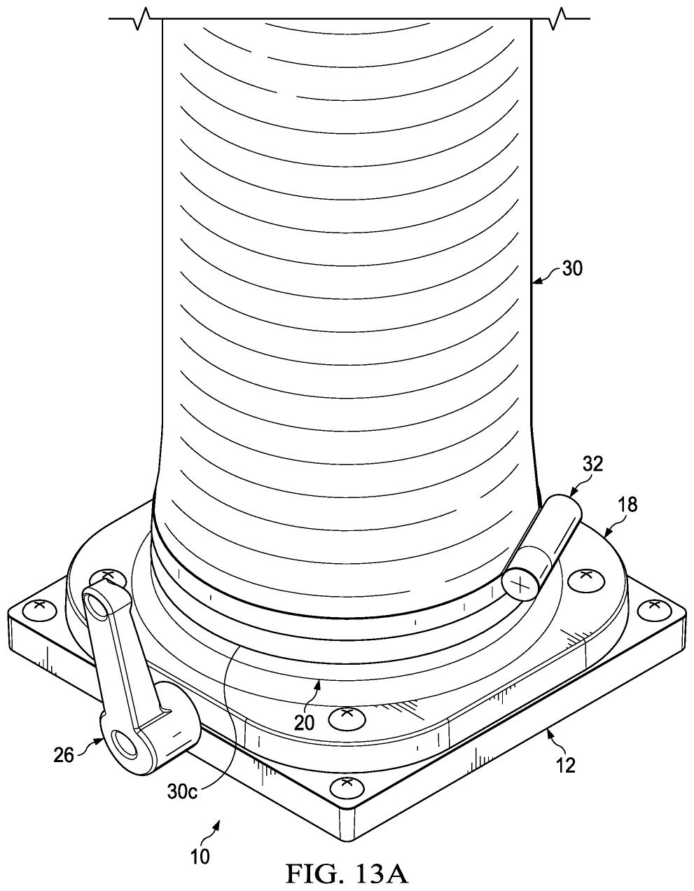

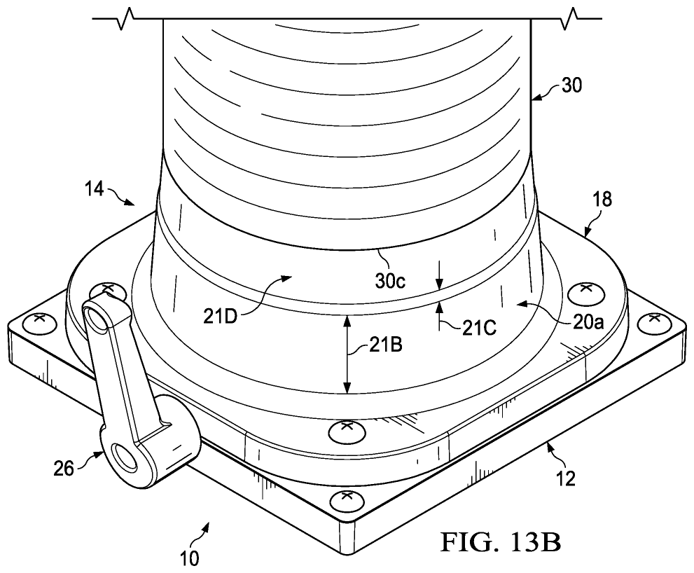

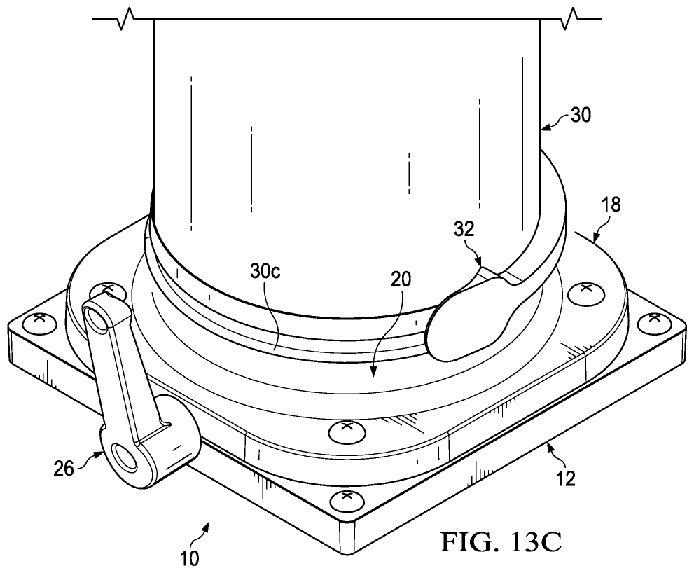

Preferably, as shown in FIG. 13A, duct 30 is moved downwardly over flange 20 until end 30c thereof is located proximate outer surface 18a of base 18. In other words, duct 30 is moved along flange 20 until the end region of duct 30 circumscribes the second region 21B of flange 20, i.e., the region of substantially constant diameter. When end 30c of duct is proximate outer surface 18a, clamp 32 is actuated to reduce the circumference of collar 32a, thereby tightening duct 30 around the circumference of second region 21B of flange 20. The decrease in duct circumference (and diameter) thus secures duct 30 and blast gate 10 to one another. The right angled surface (or very slight angle of taper) of second region 21B provides a suitable seat for the clamping action of clamp 32.

FIG. 13B and FIG. 13C show exemplary alternative methods of securing duct 30 to blast gate 10. FIG. 13B shows an instance where the duct is of a smaller diameter than in FIG. 13A. In particular, the internal diameter of duct 30 is insufficient to slide all the way down the flange 20 of blast gate 10 to proximate outer surface 18a of base 18. In this instance, duct 30 may be secured to blast gate by friction. Duct 30 is slid downwardly along flange 20 until the diameter of the particular region of flange 20 is greater than the internal diameter of duct 30, and duct becomes frictionally engaged therewith. The figure shows that the duct 30 is frictionally engaged with the tapered fourth region 21D of flange 20.

FIG. 13C shows a further alternative manner in which duct 30 may be engaged with blast gate 10. In this particular instance the duct 30 is configured as part of a quick connect system. The duct 30 therefore includes a rolled rim at its lower end 30c. This quick connect duct 30 requires a special quick connect clamping mechanism. The quick connect duct 30 with associated quick connect locking clamp 32 is operatively engaged with the second region 21B of flange 20 of blast gate 10.

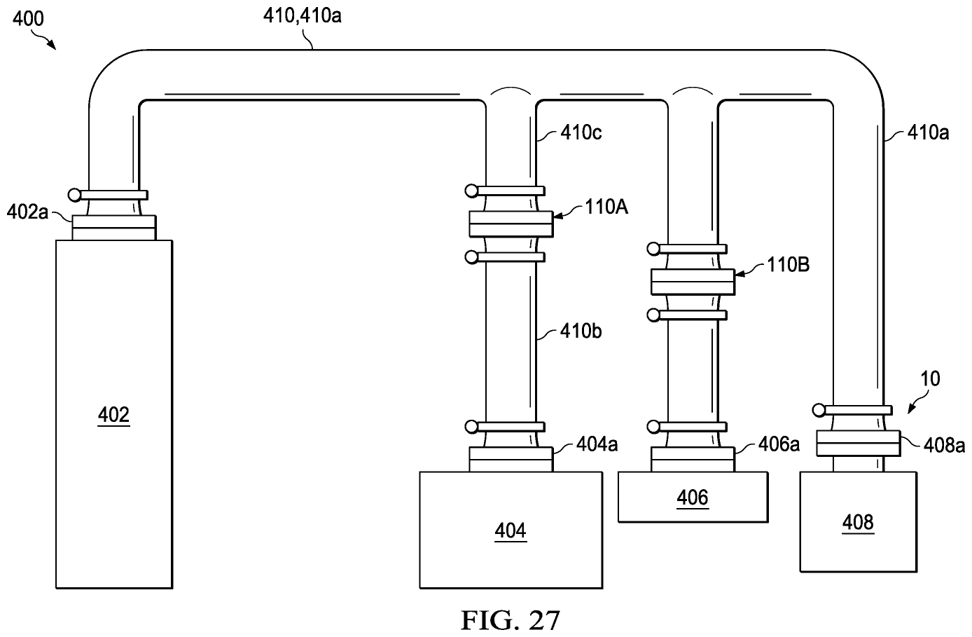

When duct 30 is firmly engaged and secured to blast gate 10 by clamp 32 as in FIG. 13A (or via friction as in FIG. 13B or a quick connect mechanism as in FIG. 13C), actuator 26 is able to be manipulated by the operator of the piece of equipment (such as any of the equipment 404, 406, and 408 illustrated in FIG. 27 and discussed later herein) to which blast gate 10 is secured. Actuator 26 may be moved in the first direction to open butterfly valve 24 and thereby place passageway 12c, 18c, 20c, (FIG. 12) in fluid communication with bore 30b of duct 30. Before or after passageway 12c, 18c, 20c is placed in fluid communication with bore 30b of duct 30, the remote dust collection apparatus (402 shown in FIG. 27) is actuated. The duct collection apparatus creates a vacuum condition within bore 30b of duct 30. When butterfly valve 24 is moved to the open position, any sawdust, woodchips, and other debris material generated by the piece of equipment will be sucked into the mouth of passageway 12c, 18c, 20c (i.e., into the opening defined by second surface 12b of plate 12). The sawdust, woodchips, and other debris material will be entrained in the air being sucked through passageway 12c, 18c, 20c, and will flow with the air into bore 30c of duct 30. The entrained sawdust, woodchips, and other debris material will travel through the bore 30b of duct 30 and will ultimately be deposited into the dust collection apparatus. When the woodworking (or other sawdust, woodchip or debris material generating operation is over, the operator of the piece of equipment will move the actuator 26 in such a way as to move butterfly valve 24 to the closed position. This movement causes valve disc 24a to obstruct and close off passageway 12c, 18c, 20c through blast gate 10. Any additional generated sawdust, woodchips, or debris material will no longer be sucked into the bore 30b of duct 30 because access to the passageway 12c, 18c, 20c is blocked. The closing of butterfly valve 24 may result in the dust collection apparatus switching off automatically.

It will be understood that while blast gate 10, 110 described herein requires manual operation by manipulation of the arm 26b of actuator 26, in other embodiments, the operation of actuator 26 may be full automated and an electrical signal may be used to move butterfly valve 24 between the closed position and open position. This automated operation of the butterfly valve 24 may be operatively linked to the operation of the piece of equipment that generates sawdust, woodchips, or other debris material or to the operation of the remote dust collection apparatus.

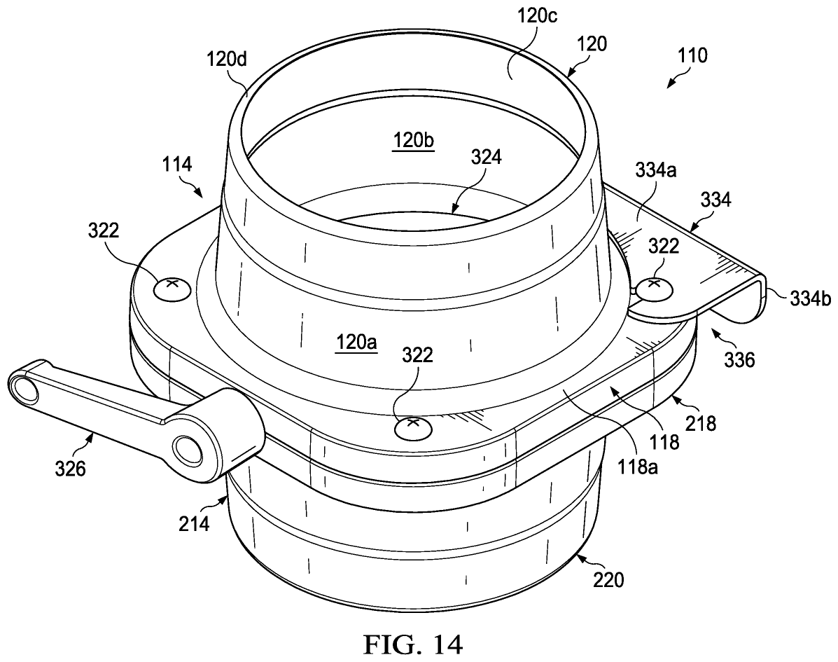

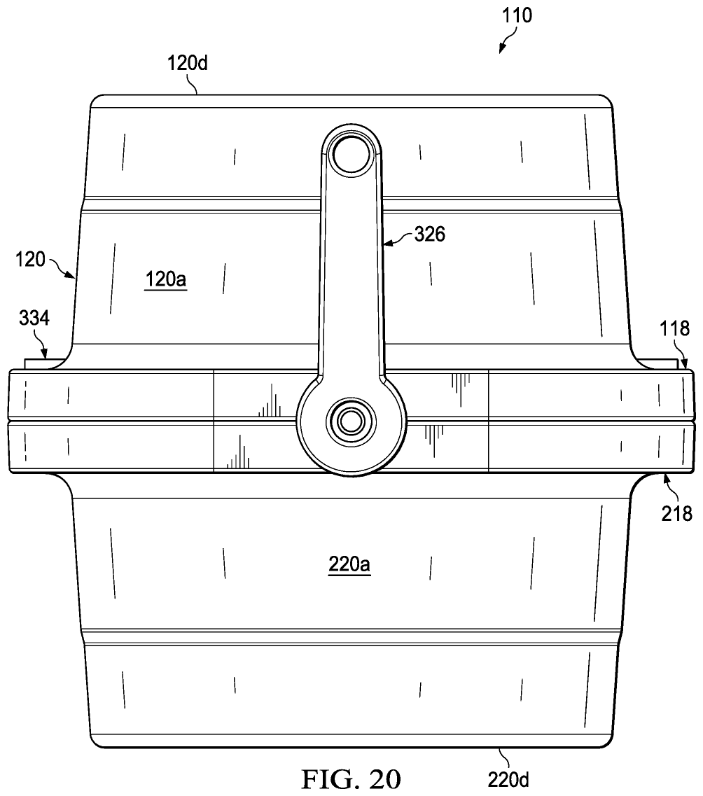

Turning now to FIGS. 14 to 23 there is shown a second embodiment of a blast gate in accordance with the present disclosure, generally indicated at 110. Blast gate 110 includes many components and features that are identical to or substantially similar to the components and features of blast gate 10. Blast gate 110 includes a first housing 114 comprising a first base 118 and a first flange 120. First housing 114 is substantially identical to housing 14; first base 118 is substantially identical to base 18, and first flange 120 is substantially identical to flange 20.

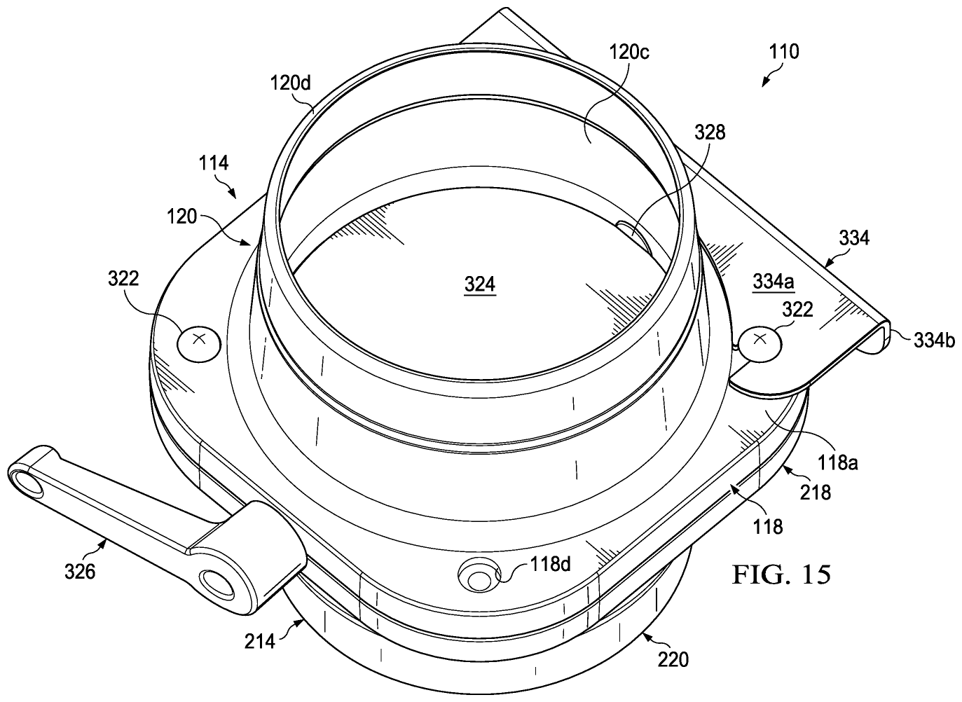

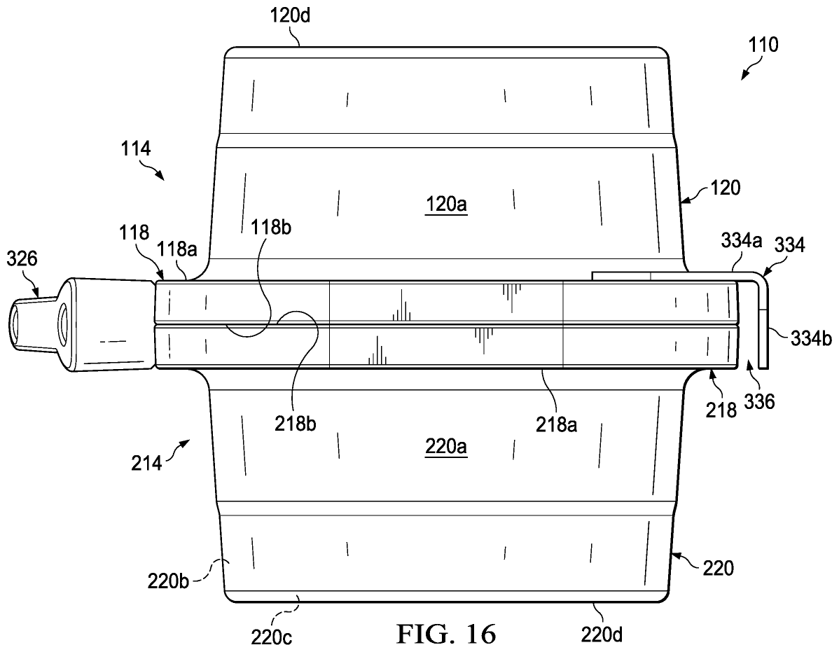

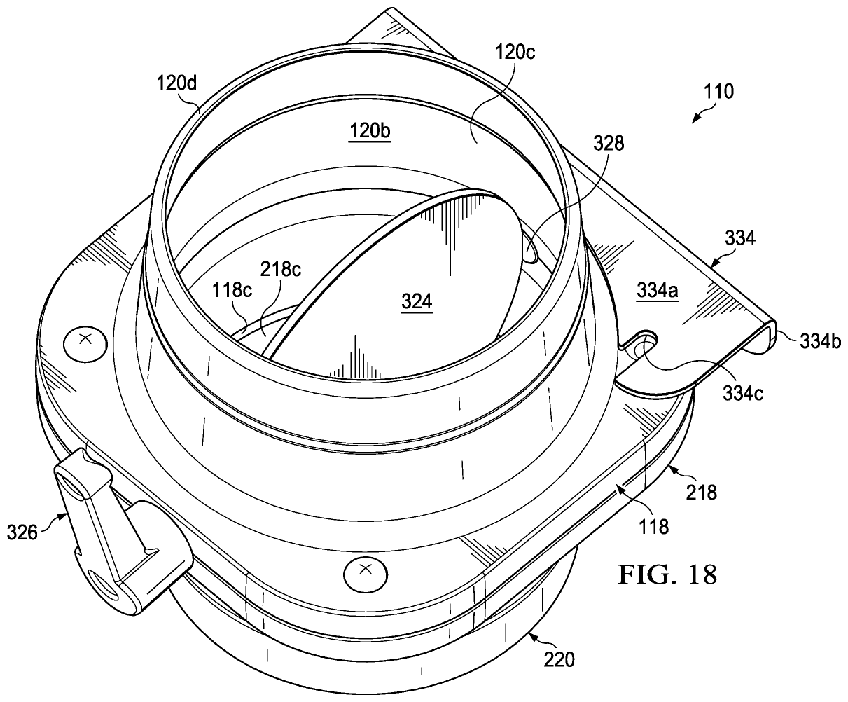

More particularly, first base 118 has an outer surface 118a, an inner surface 118b (FIG. 16), and defines a central opening 118c (FIG. 18) that extends between outer surface 118a and inner surface 118b. First base 118 further defines a plurality of holes 118d (FIG. 15) therein that extend between outer surface 118a and inner surface 118b. As with holes 18d, holes 118d may be countersunk. It will be understood that like base 18, first base 118 may be of any desired configuration when viewed from above, such as square, rectangular, circular etc. Furthermore, while opening 118c is described as a “central” opening, it will be understood that in other embodiments, the opening 118c may be located off-center on first base 118.

The annular first flange 120 of first housing 114 has an outer surface 120a, an inner surface 120b, and defines a central bore 120c that extends from proximate outer surface 118a of first base 118 to an outer edge 120d located remote from outer surface 118a. The first flange 120, like flange 20 tapers in exterior and interior diameters from first base 118 to outer edge 120d.

Blast gate 110 differs from blast gate 10 in that blast gate 110 further includes a second housing, generally indicated by the reference number 214. Second housing 214 is identical to the first housing 114 but is arranged in blast gate 110 in an inverted position relative to first housing 114.

Second housing 214 comprises a second base 218 and a second flange 220. Second housing 214 is substantially identical to first housing 114; second base 218 is substantially identical to first base 118, and second flange 220 is substantially identical to first flange 120.

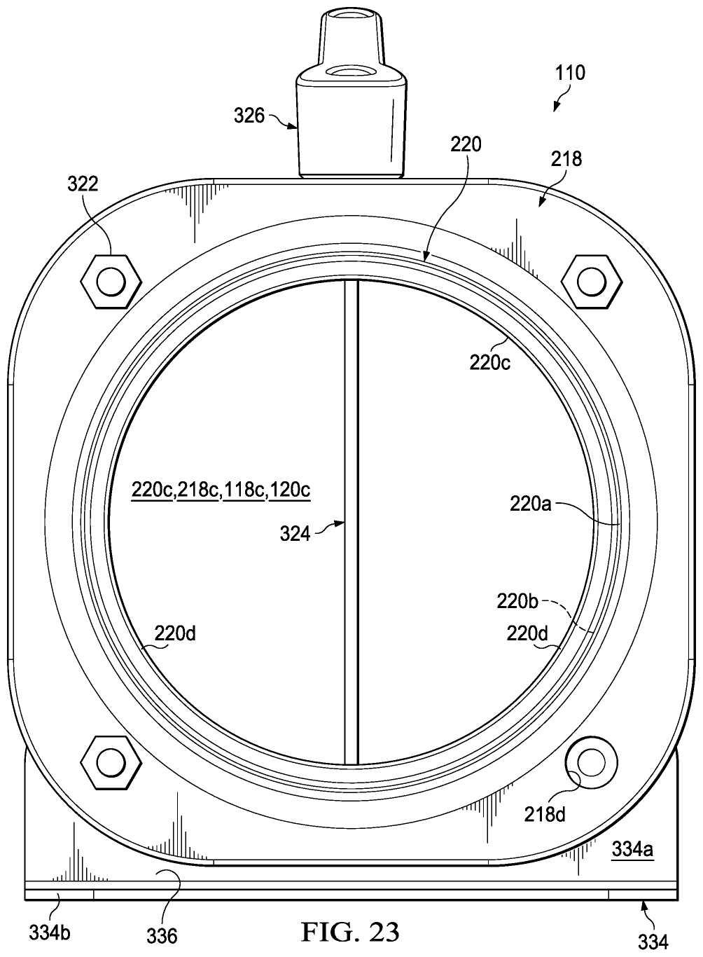

Referring to FIG. 16, second base 218 has an outer surface 218a, an inner surface 218b, and defines a central opening 218c (FIG. 18) that extends between outer surface 218a and inner surface 218b. Second base 218 further defines a plurality of through-holes 218d (FIG. 23) therein that extend between outer surface 218a and inner surface 218b. In one embodiment holes 218d may be countersunk but in other embodiments, holes 218d (like holes 118d and 18d) may not be countersunk. It will be understood that like base 118, second base 218 may be of any desired configuration when viewed from below, such as square, rectangular, circular etc. Furthermore, while opening 218c is described as a “central” opening, it will be understood that in other embodiments, the opening 218c may be located off-center on second base 218.

In one embodiment, first base 118 and second base 218 will be substantially identical in configuration. In another embodiment (not shown), first base 118 and second base 218 may be differently configured. In either of these two embodiments, the first base 118 and second base 218 will be oriented such that their inner surfaces 118b, 218b are placed in abutting contact with one another and the central openings 118c, 218c are aligned with one another. In other words, the first base 118 and second base 218 are arranged back-to-back and such that the first flange 120 and second flange 220 extend outwardly away from one another in opposite directions. In one embodiment, the through-holes 118d, 218d are aligned with one another and configured to receive a fasteners 322 therethrough. The fastener 322 may comprise a bolt and nut or another other suitable fastener that is capable of securing first base 118 and second base 218 to one another. In another embodiment, the through-holes 118d, 218d may not be vertically aligned with one another and a fastener may be inserted through one of the through-holes in one of the first base 118 and second base 218 and into the body of the other of the first base 118 and second base 218.

It will be understood that in other embodiments the inner surfaces 118b, 218b of first base 218 and second base 218, respectively, may be secured to one another by a different method. For example, inner surfaces 118b, 218b may be adhered to one another or heat welded to one another. In yet other embodiments, first and second bases 118, 218 may be integrally formed as a single, unitary component and the through holes 118d, 218d may be omitted altogether.

The annular second flange 220 of second housing 214 has an outer surface 220a, an inner surface 220b (FIG. 23), and defines a central bore 220c that extends from proximate outer surface 218a of second base 218 to an outer edge 220d located remote from outer surface 218a. The second flange 220, like first flange 120 and flange 20 tapers in exterior and interior diameters from second base 218 to outer edge 220d. It will be understood that all other features of flange 20 are included in first flange 120 and second flange 220.

Blast gate 110 also includes a butterfly valve 324 and an actuator 326. Butterfly valve 324 is substantially identical to butterfly valve 24 and will therefore not be discussed in further detail. Actuator 326 is substantially identical to actuator 26 and will therefore not be discussed in further detail. A mounting assembly 328 is provided in blast gate 110 to aid in holding butterfly valve 324 in position in conjunction with a coupler provided in actuator 326, and in enabling butterfly valve 324 to pivot within blast gate 110. Mounting assembly 328 is substantially identical to mounting assembly 28 and will therefore not be discussed in further detail. The only difference between actuator 326 and mounting assembly 328 relative to actuator 26 and mounting assembly 28 is that instead being located adjacent openings defined in sidewalls of a base 18 and a plate 12, actuator 326 and mounting assembly 328 are located adjacent holes defined in the sidewalls of first base 118 and second base 218. The structure and function of actuator 326, mounting assembly 328, and butterfly valve 324 are identical to the structure and function of actuator 26, mounting assembly 28, and butterfly valve 24 and will therefore not be discussed in further detail.

Blast gate 110 defines a passageway therethrough that extends from outer edge 120d through to outer edge 220d. The passageway is comprised of the central bore 120c of first flange 120, the central opening 118c of first base 118, the central opening 218c of second base 218, and the central bore 220c of second flange 120. The passageway is indicated in FIG. 23 by the reference characters 120c, 118c, 218c, 220c. Butterfly valve 324 is located within blast gate 110 so as to be manipulated by actuator 326 to selectively close passageway 120c, 118c, 218c, 220c, as illustrated in FIG. 15. In one embodiment, butterfly valve 324 is located approximately midway between outer edge 120d and outer edge 220d. Butterfly valve 324 may further be manipulated by actuator 326 to move to an open position (FIG. 18) where fluid communication is established between central bore 120c of first flange 120 and central bore 220c of second flange 220. FIG. 18 shows actuator 326 being rotated in a direction indicated by arrow “E” to move butterfly valve 324 into the open position. Since butterfly valve 324 is fixedly secured to actuator 326 (via a valve stem identical to valve stem 24b), butterfly valve 324 will also move in the direction indicated by arrow “E” and will therefore become oriented substantially parallel to a direction in which air is able to flow through passageway 120c, 118c, 218c, 220c. The direction of airflow is either from outer edge 120d to outer edge 220d of vice versa.

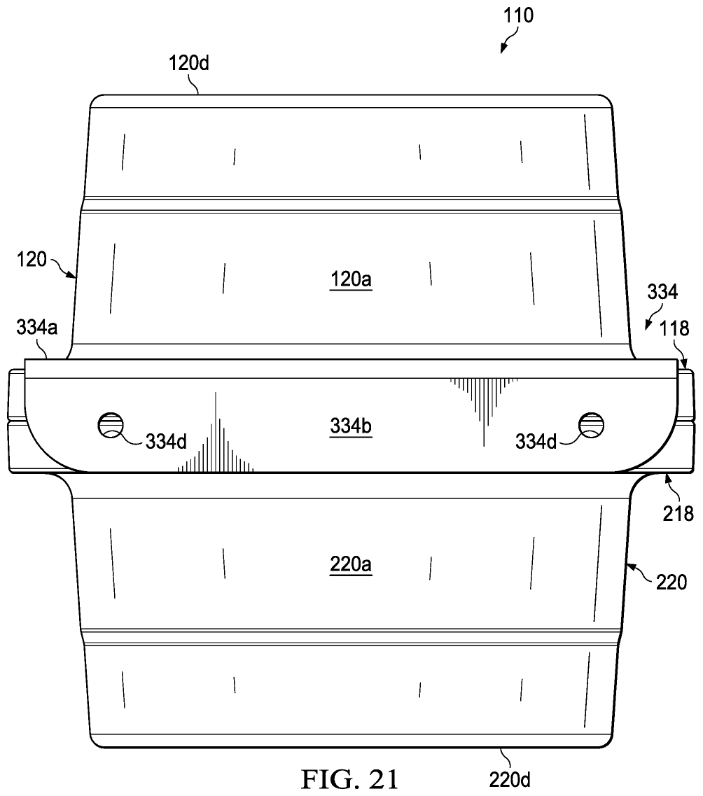

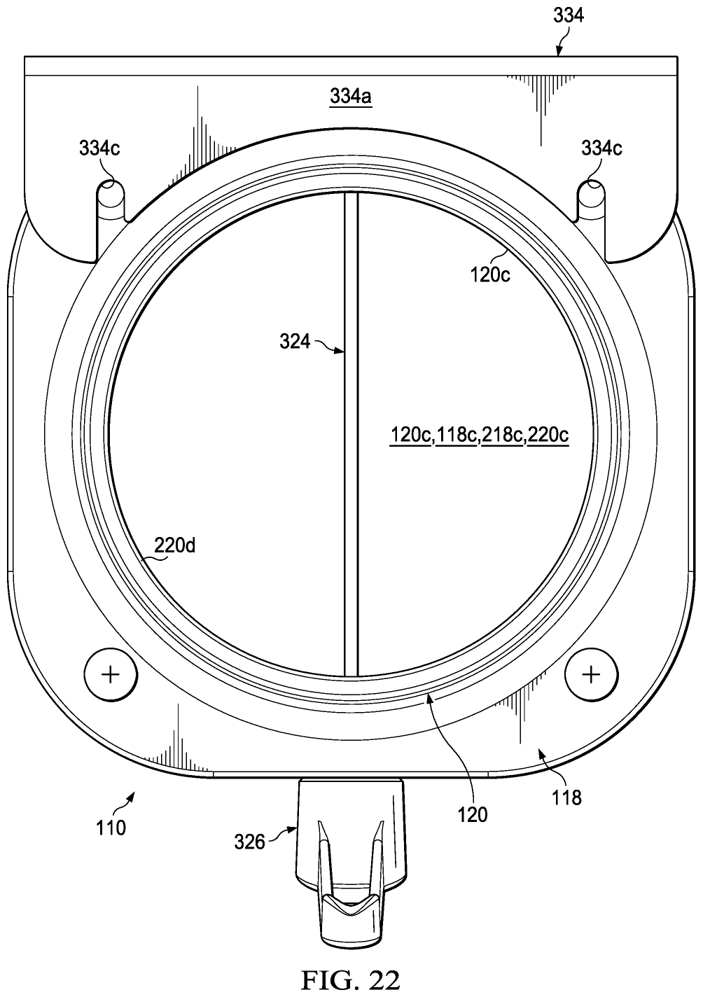

Blast gate 110 further includes a mounting bracket 334 that may be selectively engaged with first housing 114. Mounting bracket 334, as illustrated, is substantially L-shaped and includes a first leg 334a and a second leg 334b oriented at right angles to one another. First leg 334a and second leg 334 of mounting bracket 334 may be of substantially a same length as one of the sides of the square-shaped first base 118. This can best be seen in FIGS. 21 and 22. (It will be understood that the mounting bracket 334 could, of course, be longer or shorter than the first base's side.) First leg 334a is configured to rest on outer surface 118a of first base 118 and to be engaged thereto via two of the fasteners 322 which secure first base 118 to second base 218. As best seen in FIG. 22, first leg 334a defines a pair of elongate slots 334c therein. Each slot 334c is oriented at right angles to second leg 334b, originates in an outer edge (not numbered) of first leg 334a, and extends inwardly toward second leg 334b. Slots 334c are oriented at right angles to the outer edge and parallel to one another. Slots 334c are also spaced a distance laterally apart from one another that is equivalent to the distance between adjacent through-holes 118d in first base 118. Slots 334c also extend between an outer surface and an inner surface of first leg 334a.

Second leg 334b is best seen in FIG. 21. Second leg 334b, as illustrated, is of a height that is generally equivalent of the combined height of first base 118 and second base 218. The height of each of the first base 118 and second base 218 is measured from the outer surface thereof to the respective inner surface. The height of second leg 334b is measured from outer surface 118a to outer surface 218a of first and second mounting brackets 118, 218. It will be understood that the height of second leg 334b may be more than the combined heights of first and second bases 118, 218, equal to the combined heights thereof, or less than the combined heights thereof. Second leg 334b defines one or more apertures 334d therein that extend between an inner surface and an outer surface of second leg 334b. The purpose of apertures 334d will be discussed later herein.

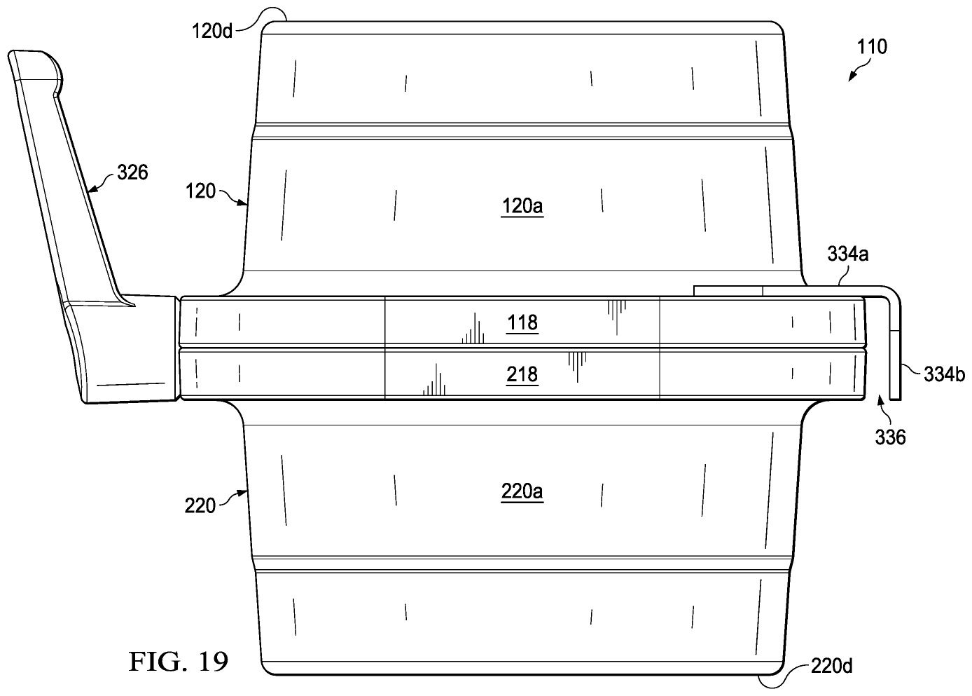

To connect mounting bracket 334 to first base 118, the inner surface of first leg 334a is placed in abutting contact with outer surface 118a of first base 118 and the slots 334c are aligned with two of the through-holes 118d. Fasteners 322 are inserted through the aligned slots 334c and holes 118d (and the holes 218d of second base 218) in order to secure mounting bracket 334 to first base 118. When first leg 334a is secured to first base 118, second leg 334b of mounting bracket 334 is spaced a distance laterally away from a side surface of one or both of first base 118 and second base 218. A gap 336 (FIG. 19) is defined between the inner surface of second leg 334b and the side surface of one or both of the first base 118 and second base 218. The size of the gap 336 is dictated by the width of the first wall 334a of mounting bracket 334 and/or the width of the first base 118 which extends outwardly away from the outer surface 120a of first flange 120. The width of the first wall 334a is measured from the outer edge (in which the openings to the slots 334c are defined) to proximate the second leg 334b.

Mounting bracket 334 may be engaged with the upper surface of first base 118 proximate any of the sides of the first base 118 other than the one from which the actuator 326. The particular side selected for engagement will be based upon the layout of the ductwork in a particular dust collection system and the availability of support surfaces upon which to anchor blast gate 110. This will be discussed hereafter.

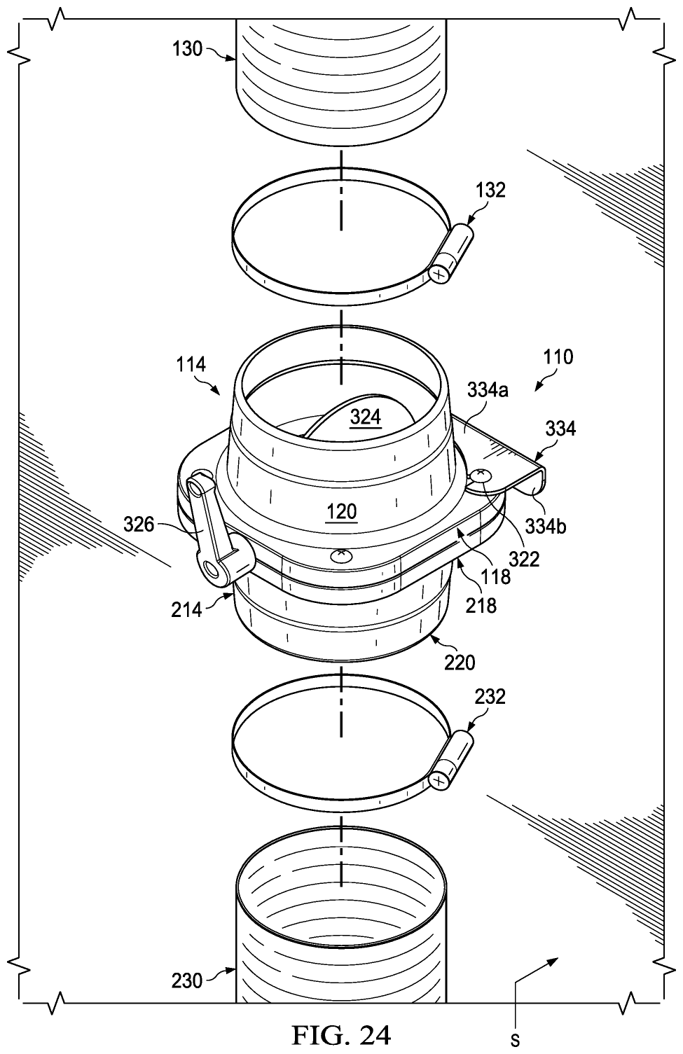

Referring now to FIGS. 24 through 26, the use of blast gate 110 as an inline blast gate in a duct collection system is illustrated. Dust collection system includes a first duct 130 and associated first clamp 132 and a second duct 230 and associated second clamp 132. Ducts 130 and 230 are substantially identical in structure and function to duct 30 discussed earlier herein. Clamps 132 and 232 are substantially identical in structure and function to clamp 32 discussed earlier herein.

In order to support first duct 130 and second duct 230, mounting bracket 334 is disengaged from blast gate 110 by rotating the fasteners 322 in such a direction to allow mounting bracket 334 to slide off first base 118. The outer surface of mounting bracket 334 is placed against the support surface “S” in a desired position and orientation to suit the needs of the dust collection system. Although not illustrated herein, it will be understood that additional fasteners are then inserted through the apertures 334d defined in second leg 334b of mounting bracket 334. The additional fasteners are screwed into the support surface “S” in order to lock mounting bracket 334 in the desired position and orientation. Blast gate 110 is then brought into the vicinity of mounting bracket 334 until the partially unscrewed fasteners 322 slide into the slots 334c defined in first leg 334a of mounting bracket 334. Fasteners 322 are then rotated in the correct direction to tightly secure blast gate 110 to mounting bracket 334. When this engagement of blast gate 110 with mounting bracket 334 is completed, the heads of the additional fasteners will be located into the gap 336 defined between second leg 334b and the side of the first base 118.

The first duct 130 and second duct 230 are then engaged with the surface-mounted blast gate 110. FIG. 24 shows first duct 130 and first clamp 132 aligned with one another and positioned in alignment with first housing 114 of blast gate 110. The figure also shows second duct 230 and second clamp 232 aligned with one another and positioned in alignment with second housing 214 of blast gate 110. FIG. 24b shows first clamp 132 engaged around an outer surface of first duct 130 and the duct being moved in the direction indicated by arrow “F” towards first flange 120 of first housing 114. The figure also shows second clamp 232 engaged around an outer surface of second duct 230 and the duct being moved in the direction indicated by arrow “G” towards second flange 220 of second housing 214.

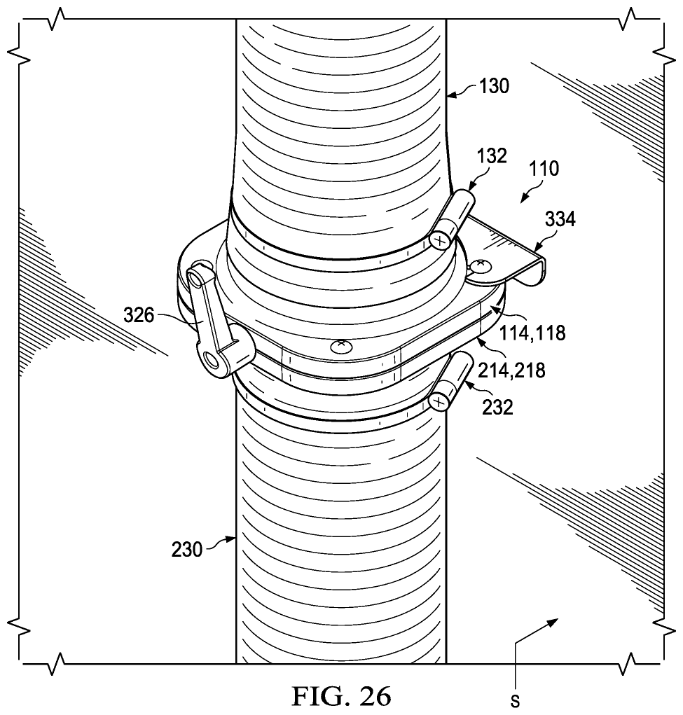

FIG. 26 shows first duct 130 lowered to a position around the outer surface of first flange of blast gate 110 in a substantially identical manner as to how duct 30 is engaged with blast gate 10 as illustrated in FIG. 13A. (Duct 30 may, alternatively, be engaged with blast gate 10 by friction as illustrated in FIG. 13B or via a quick-connect mechanism as in FIG. 13C.) First clamp 132 is tightened to lock first duct 130 in place on blast gate 110. Similarly, FIG. 26 shows second duct 230 raised to a position around the outer surface of the second flange of blast gate 110 in a substantially identical manner as the engagement of first duct 130 therewith. Second clamp 232 is tightened to lock second duct 230 in place on blast gate 110.

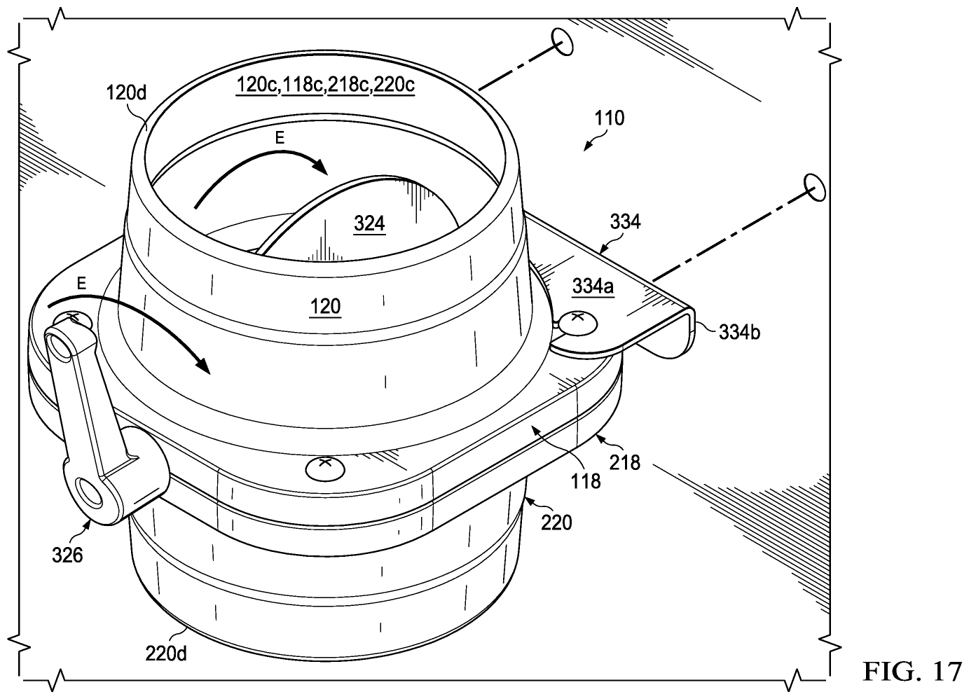

Once blast gate 110 is installed inline between first duct 130 and second duct 230, the butterfly valve 324 (FIG. 14) is able to be moved between a closed position and an open position by manipulating the actuator 326. When butterfly valve 324 is moved in the direction “E” as illustrated in FIG. 17, the valve is opened and the bore of first duct 130 is placed in fluid communication with the bore of second duct 230 via passageway 120c, 118c, 218c, 220c (FIG. 17).

FIG. 27 shows an exemplary dust collection system 400 comprising a dust collection apparatus 402, a first piece of woodworking equipment 404, a second piece of woodworking equipment 406, and a third piece of woodworking equipment 408. Ductwork 410 connects dust collection apparatus 402 to all of the first piece of woodworking equipment 404, second piece of woodworking equipment 406, and the third piece of woodworking equipment 408. Each piece of equipment in the dust collection system 400 includes a dust port to which the ductwork 410 is able to be connected. The dust ports are indicated at 402a, 404a, 406a, and 408a, respectively. Blast gates in accordance with the present disclosure are located in various places through dust collection system 400. For example, the third piece of woodworking equipment 404 has a first embodiment blast gate 10 engaged with the dust port 404a. A length of duct of the ductwork 410 is engaged with the flange of the blast gate 10 in a substantially identical manner to the way the duct 30 is engaged with the blast gate 10 shown and described in FIGS. 11 through 13C. Second embodiment blast gates 110A and 110B are engaged between sections of the ductwork 410 extending downwardly from a main duct 410a to the first piece of equipment 404 and the second piece of equipment 406, respectively.

If a woodworker wishes to work on the first piece of woodworking equipment, he or she will ensure the butterfly valves in the blast gates 110B and 10 to the second and third pieces of equipment 406, 408, respectively, are in the closed position. He or she will then open the blast gate 110A, actuate the dust collection apparatus 402, and begin to perform a woodworking operation. Any sawdust, woodchips, and other debris material produced by the first piece of equipment 404 will be sucked through the duct port 404a, into the first section 410b of ductwork 410, through the open butterfly valve of blast gate 110A into the bore of the second section 410c of the ductwork and then into the main duct 410a to the dust collection apparatus 402.

If the woodworker wishes to then switch to using the third piece of woodworking equipment 408, he or she will close the blast gate 110A, open the blast gate 10, actuate the dust collection apparatus 402, and then being a woodworking operation on the third piece of woodworking equipment 408. Sawdust, woodchips, and other debris material will be sucked through the dust port 408a, through the open butterfly valve of the blast gate 10 and into the main duct 410a. When that woodworking operation is over, the woodworker will once again close the butterfly valve of blast gate 10.

It should be understood that while mounting bracket 334 is described and illustrated as being selectively securable to first base 118 of first housing 114, in other embodiments, mounting bracket 334 may be selectively securable to second base 218 of second housing 214. Furthermore, it will be understood that in other embodiments, mounting bracket 334 may be engaged with blast gate 10 in a similar manner to how mounting bracket 334 is engaged with blast gate 110. It will further be understood that if mounting bracket 334 is engaged with blast gate 10, the first leg 334a of mounting bracket 334 may be secured to base 18 or to plate 12. First leg 334a of mounting bracket 334 may be reconfigured to engaged base 18 or plate 12 in any desired way and such that the second leg 334b of the mounting bracket 334 is able to be positioned a distance from blast gate 10 in order to be able to secure blast gate 10 to any desired suitable support surface “S”.

The dust collection system 400 disclosed herein has been described as useful in conjunction with woodworking equipment and preforming woodworking operations. It should be understood, however, that the disclosed blast gate 10, 110 may be utilized in any environment where any other type of equipment is used that generates debris material during performance of an operation, and wherein that debris material is extracted from the equipment utilizing ductwork.

Furthermore, while the blast gate 10, 110 has been disclosed as being connectable to dust collection apparatus that utilizes vacuum or airflow to remove debris material from the environment of a piece of equipment, the blast gate may be utilized in other types of fluid-driven debris material collection systems.

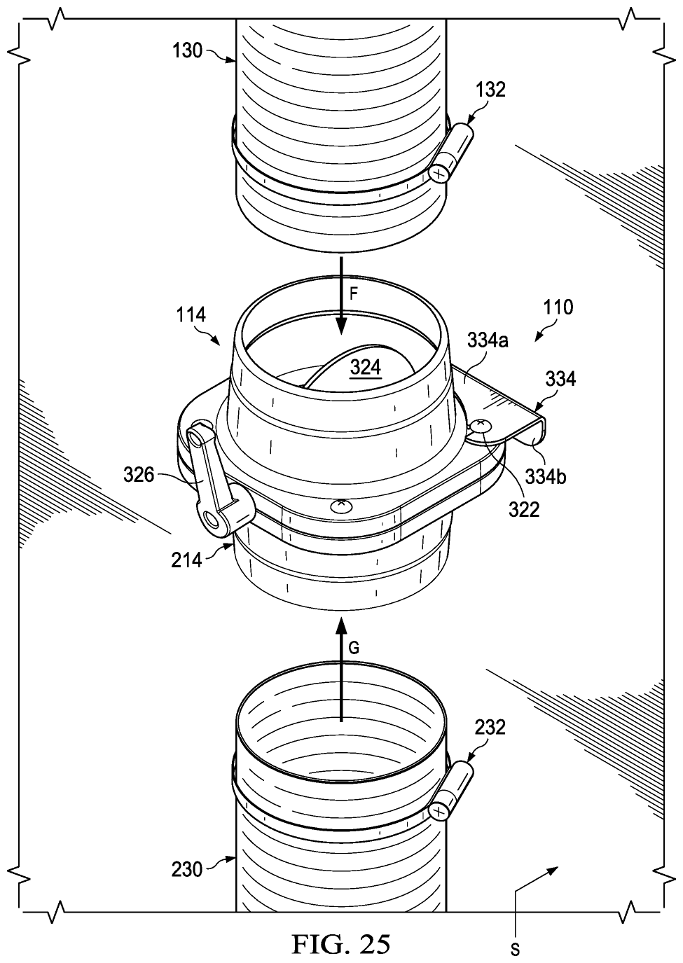

In summary, blast gate 10, 110 is a modular component which enables a user to connect any one of a wide variety of different duct, hoses, or pipes (such as duct 30) into a dust collection system or dust extraction system, such as system 400 shown in FIG. 27. Additionally, the modular blast gate 10 disclosed herein enables the user to use any one of a wide variety of different connector mechanisms (such as clamp 32 shown in FIG. 13A, or friction shown in FIG. 13B, or a quick connect clamp 32 shown in FIG. 13C) to secure a duct, hose or pipe to the blast gate. Furthermore, two of the disclosed modular blast gates may be combined into a single device 110 to connect two ducts, hoses, or pipes to one another. The disclosed combined blast gates 110 may enable the woodworker or other person to use different connector mechanism to secure the two ducts, hoses, or pipes to one another. For example, a first of the two ducts may be secured to one of the combined blast gates via friction and a second of the two ducts may be secured to the other of the combined blast gates via a clamp-type connector mechanism. Additionally, the disclosed blast gate 10 is configured to enable the blast gate to be connected to a mounting plate 12 to secure the blast gate 10 to a piece of equipment (or the blast gate may be connected to the equipment without the mounting plate 12). Furthermore, the disclosed blast gate may be secured to a support surface such as a wall as illustrated in FIG. 14. Alternatively, as discussed earlier herein, the blast gate may be secured to another blast gate and the combined blast gates 110 may then be secured to a support surface “S”, such as a wall as illustrated in FIG. 25. In summary, the disclosed blast gate 10 is a modular component that is adapted to be connected to any duct or tool i.e., piece of equipment that generates dust, shavings, and the like.

It will be understood that while blast gate 10 has been described herein as including a butterfly valve 24, in other embodiments, the butterfly valve may be replaced with a gate valve or any other desired type of valve suitable for operation in a dust collection system or dust extraction system.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A blast gate for use in a dust collection system, said blast gate comprising:
a base which is planar;
a flange which originates in an outer surface of the base, wherein the base and flange are formed from a same material, and wherein the flange comprises:
a first region extending outwardly from the base in a first direction, wherein said first region is of a substantially constant diameter and is adapted to selectively enable securement of a duct to the first region via a first connector mechanism; and
a second region extending outwardly from the first region, wherein a portion of the second region extending outwardly from the first region is of a same diameter as the first region and the second region then tapers in diameter from the portion of the second region moving outwardly away from the first region in the first direction, and wherein said second region is adapted to selectively enable securement of the duct to the second region via a second connector mechanism which is different from the first connector mechanism.

2. (canceled)

3. The blast gate according to claim 1, wherein the flange is annular in configuration.

4. (canceled)

5. (canceled)

6. (canceled)

7. The blast gate according to claim 1, further comprising:
a passageway defined through the base and the flange, wherein the passageway is adapted to be connected to a bore defined in the duct of the dust collection system.

8. The blast gate according to claim 7, further comprising:
a valve disposed within the passageway and being movable between an open position and a closed position.

9. The blast gate according to claim 8, further comprising an actuator for moving the valve between the open position and the closed position.

10. The blast gate according to claim 8, wherein the valve is a butterfly valve.

11. The blast gate according to claim 1, wherein the base is configured for selective engagement to a base of an identical second blast gate.

12. The blast gate according to claim 1, further comprising a mounting plate engageable with the base, wherein the mounting plate is adapted to secure the base to a piece of equipment that generates particulate material.

13. The blast gate according to claim 1, further comprising a mounting bracket engageable with the base, wherein the mounting bracket is adapted to secure the base to a support surface.

14. The blast gate according to claim 1, further comprising an identical second blast gate securable to the blast gate in a back-to-back configuration to form a combined blast gate device that is adapted to selectively secure two ducts of a duct collection system to one another.

15. A dust collection system comprising:
a dust collection apparatus;
ductwork adapted to connect at least one piece of equipment to the dust collection apparatus;
at least one blast gate connectable to the ductwork; wherein the at least one blast gate includes:
a base which is planar;
a flange which originates in an outer surface of the base wherein the base and flange are formed from a same material, wherein the flange comprises:
a first region extending outwardly from the base in a first direction, wherein said first region is of a substantially constant diameter and selectively enables securement of a duct of the ductwork to the at least one blast gate via a first connector mechanism; and
a second region extending outwardly from the first region, wherein a portion of the second region extending outwardly from the first region is of a same diameter as the first region and the second region tapers in diameter moving away from the first region in the first direction, wherein the second region selectively enables securement of the duct of the ductwork to the at least one blast gate via a second connector mechanism which is different from the first connector mechanism.

16. The dust collection system according to claim 15, wherein the at least one blast gate further comprises:
a passageway defined through the base and the flange, wherein the passageway is placed in fluid communication with the duct of the ductwork; and
a valve disposed within the passageway and being movable between an open position and a closed position.

17. The dust collection system according to claim 16, wherein the valve is a butterfly valve.

18. The dust collection system according to claim 16, further comprising a second blast gate identical to the blast gate, wherein the base of the blast gate and a base of the second blast gate are secured to one another and the flange of the blast gate and a flange of the second blast gate extend outwardly in opposite directions from one another; and wherein the blast gate is connected to a first duct of the ductwork and the second blast gate is connected to a second duct of the ductwork.

19. A method of collecting debris material generated by a piece of equipment during performance of operation therewith, said method comprising:
providing a blast gate comprising a base and a flange formed from a same material, wherein the flange has a first region extending outwardly from a planar outer surface of a base, said first region being of a substantially constant diameter and being configured to be selectively engageable with a duct via a first connector mechanism, and said blast gate further including a second region which extends outwardly from the first region and away from the base, wherein a portion of the second region extending outwardly from the first region is of a same diameter as the first region and said second region tapers in diameter moving in a direction away from the portion of the second region, said second region being configured to be selectively engageable with the duct via a second connector mechanism that is different from the first connector mechanism;
positioning the blast gate between the piece of equipment and the duct;
selecting one of the first region and the second region of the blast gate to connect the duct thereto;
selecting the respective one of the first connector mechanism and the second connector mechanism to use in conjunction with the one of the first region and the second region;
connecting the duct to the selected one of the first region and the second region via the respective selected one of the first connector mechanism and the second connector mechanism;
terminating the duct in a remote dust collection apparatus,
moving a valve within the blast gate to an open position;
placing the piece of equipment in fluid communication with the remote dust collection apparatus via the opened valve and the duct;
suctioning air with entrained debris material generated by the piece of equipment through the opened valve and into the duct;
collecting the entrained debris material in the remote dust collection apparatus.

20. The method according to claim 19, wherein providing the valve comprises providing a butterfly valve in the blast gate, and wherein the moving the valve to the open position comprises pivoting the butterfly valve about a pivot axis and into the open position.

21. The blast gate according to claim 1, wherein the first region of the flange enables securement of the duct thereto by way of a mechanical connector as the first connector mechanism and the second region enables securement of the duct thereto by friction as the second connector mechanism.

22. The dust collection system according to claim 15, wherein the first region of the flange enables securement of the duct thereto by way of a mechanical connector as the first connector mechanism and the second region enables securement of the duct thereto by friction as the second connector mechanism.

23. The method according to claim 19, wherein selecting the one of the first connector mechanism and the second connector mechanism includes selecting a mechanical connector as the first connection mechanism and selecting friction as the second connector mechanism.
